(19) United States
(12) Patent Application Publication
(10) Pub. No.: US 2026/0270153 A1
(43) Pub. Date: Sep. 10, 2026

(54) METHODS AND SYSTEMS FOR ENHANCED CLUSTER HEALTH MONITORING AND UNHEALTHY NODE DETECTION THROUGH DROP OUT-ACCUMULATION

(71) Applicant: Penguin Solutions, Inc., Fremont, CA (US)

(72) Inventors: Nicholas Mccollum, Decatur, AL (US); Kevin Manalo, Saint Johns, FL (US)

(73) Assignee: Penguin Solutions, Inc., Fremont, CA (US)

(21) Appl. No.: 19/543,744

(22) Filed: Feb. 18, 2026

Related U.S. Application Data
(63) Continuation of application No. PCT/US25/18337, filed on Mar. 4, 2025.

(30) Foreign Application Priority Data
Mar. 4, 2025 (WO) PCT/US25/18337

(51) Int. Cl. H04L 41/142; G06F 11/34; H04L 43/04

(52) U.S. Cl. CPC H04L 41/142; G06F 11/3409; H04L 43/04

(57) ABSTRACT

A system and method includes accessing computing node pair health testing data associated with a peer group of the cluster of computing nodes; deriving, for each of two or more pairs of computing nodes of the peer group, bidirectional performance information characterizing a performance of the respective pair of computing nodes; computing a peer-relative performance distribution across the peer group of computing nodes; automatically encoding, for each pair of computing nodes of the two or more pairs, a respective machine-readable node pair deviation state with an indication of whether the respective pair exhibits peer-relative underperformance or peer-relative conformance based on the bidirectional performance information and the peer-relative performance distribution; and exposing the machine-readable node pair deviation states, wherein the machine-readable node pair deviation states are consumable data signals by one or more cluster management interfaces supporting operational control of workload placement and resource utilization within the cluster of computing nodes.

### CROSS-REFERENCE TO RELATED APPLICATIONS

This application claims the benefit of priority to PCT Patent Application No. PCT/US25/18337, filed on Mar. 4, 2025, which claims benefit of priority to U.S. patent application Ser. No. 18/604,417, filed on Mar. 13, 2024, each incorporated herein by reference in their entirety for all purposes.

### TECHNICAL FIELD

This invention relates generally to the computer cluster management field, and more specifically to new and useful systems and methods for conducting health checks of and detecting unhealthy computing nodes in the computer cluster management field.

### BACKGROUND

Traditional methods for ensuring the integrity and performance of a cluster of computers often rely heavily on self-reporting mechanisms from the hardware components or computers within the cluster. These methods await error signals such as logs, messages, or other indications from the hardware to identify issues. However, this approach is insufficient as it fails to detect problems that do not self-report, leading to undiagnosed issues that degrade cluster performance.

Some systems may employ single-point health checks provided by server hardware vendors, which monitor the status of a single computing node and its components. These systems are limited as they depend on the hardware's ability to recognize and communicate its own failures. Such reliance on self-reporting not only overlooks silent failures but also neglects the health of the network interconnected components. Given that modern GPU servers and similar servers are increasingly connected via high-speed fiber-optic networks, direct attach copper, and/or the like, this oversight can result in unacknowledged bottlenecks and faults within the cluster's communication infrastructure.

The technology introduced herein addresses the aforementioned limitations by providing a robust health check framework that actively tests nodes bi-directionally against their peers within the cluster. At least this innovative approach ensures the reliable detection of faulty computing nodes within a cluster without depending on vendor-specific, single-server health checks. By facilitating indirect testing of the network interconnects, the invention comprehensively evaluates the health of the entire cluster of computers, including various network components of the cluster of computers. Consequently, the inventions described herein offer improved systems and methods for maintaining optimal cluster performance and reliability.

### SUMMARY OF THE INVENTION(S)

In some embodiments, a computer-program product for peer-relative performance management in a cluster of computing nodes may store computer instructions that, when executed by processing circuitry, perform operations comprising: implementing a cluster performance insight interface in operable command communication with an administrative computing node of the cluster of computing nodes; accessing, via the cluster performance insight interface, computing node pair health testing data associated with a peer group of the cluster of computing nodes; deriving, for each of two or more pairs of computing nodes of the peer group, bidirectional performance information characterizing a performance of the respective pair of computing nodes; computing a peer-relative performance distribution across the peer group of computing nodes based on the derived bidirectional performance information; automatically generating, for each pair of computing nodes of the two or more pairs, a machine-readable node pair deviation state, wherein automatically generating the machine-readable node pair deviation state for a pair of computing nodes comprises: computing a quantified degree of peer-relative performance deviation for the pair based on the respective bidirectional performance information and the peer-relative performance distribution; determining whether the quantified degree of peer-relative performance deviation for the pair satisfies a performance deviation threshold; encoding, within the node pair deviation state, an indication that the respective pair exhibits peer-relative underperformance when the quantified degree of peer-relative performance deviation satisfies the performance deviation threshold; and encoding, within the node pair deviation state, an indication that the respective pair exhibits peer-relative conformance when the quantified degree of peer-relative performance deviation fails to satisfy the performance deviation threshold; exposing the machine-readable node pair deviation states, wherein the machine-readable node pair deviation states are consumable data signals by one or more cluster management interfaces supporting operational control of workload placement and resource utilization within the cluster of computing nodes.

In some embodiments, exposing the machine-readable node pair deviation states comprises: providing the machine-readable node pair deviation states to a cluster management system, thereby enabling the cluster management system to initiate corrective actions on one or more computing nodes of the peer group.

In some embodiments, initiating the corrective actions includes one or more of: setting, for each of one or more computing nodes of the peer group exhibiting peer-relative underperformance according to the associated machine-readable node pair deviation states, a respective performance-sensitive workload eligibility status to a first mode in which the computing node is ineligible for assignment to performance-sensitive workloads; or setting, for each of one or more computing nodes of the peer group exhibiting peer-relative conformance according to the associated machine-readable node pair deviation states, a respective performance-sensitive workload eligibility status to a second mode in which the computing node is eligible for assignment to performance-sensitive workloads.

In some embodiments, setting the performance-sensitive workload eligibility status to the first mode transitions the respective computing node into a quarantine state in which the computing node is ineligible for assignment to any workloads.

In some embodiments, deriving the bidirectional performance information for a respective pair of computing nodes comprises: extracting, from the computing node pair health testing data, a plurality of bidirectional performance test results corresponding to multiple pairwise interactions between a first computing node and a second computing node within the peer group; and aggregating the bidirectional test results to generate one or more bidirectional performance parameter values for the pair of computing nodes.

In some embodiments, each bidirectional performance test result includes one or more bidirectional performance values, the one or more bidirectional performance values including: a comparative data processing performance value representing a difference or ratio between a data processing rate of the first computing node and a data processing rate of the second computing node during a bidirectional test; or a comparative data transmission performance value representing a difference or ratio between a data transmission rate observed in a first direction and a data transmission rate observed in a reverse direction of the bidirectional test; and the one or more performance parameter values comprise: an aggregated comparative data process performance value representing an aggregation of one or more comparative data process performance values within the extracted set of bidirectional performance test results; an aggregated comparative data transmission performance value representing an aggregation of one or more comparative data transmission performance values within the extracted set of bidirectional performance test results.

In some embodiments, the computer instructions may further perform operations comprising: detecting, via the cluster performance insight interface, that additional computing node pair health testing data has been generated; accessing the additional computing node pair health testing data via the cluster performance insight interface; and updating the bidirectional performance information according to the updated additional computing node pair health testing data, thereby enabling the one or more cluster management interfaces to perform operational control of workload placement and resource utilization according to machine-readable deviation states updated in near-real-time.

In some embodiments, updating the peer-relative bidirectional performance information comprises: identifying one or more additional bidirectional performance test results corresponding to the additional computing node pair health testing data; detecting that one or more previously received bidirectional performance test results exceed a temporal freshness threshold; generating one or more updated bidirectional parameter values using the one or more additional bidirectional performance test results and excluding the one or more previously received bidirectional performance test results that exceed the temporal freshness threshold.

In some embodiments, the computer instructions, when executed by the processing circuitry, perform operations further comprising: computing the peer-relative performance distribution for the peer group comprises: aggregating the bidirectional performance information from each pair of computing nodes to compute a central tendency metric and a dispersion metric; and computing the quantified degree of peer-relative performance deviation for a respective pair of computing nodes comprises: determining a directional performance offset of the bidirectional performance information associated with the respective pair of computing nodes relative to the central tendency metric of the peer-relative performance distribution; and scaling the directional performance offset based on the dispersion metric of the peer-relative performance distribution to determine a normalized deviation measure.

In some embodiments, the quantified degree of peer-relative performance deviation satisfies the performance deviation threshold when the normalized deviation measure satisfies a scaled directional performance offset threshold.

In some embodiments, the computer instructions, when executed by the processing circuitry, perform operations further comprising: detecting that a computing node has been removed from the peer group; and updating the peer-relative performance distribution excluding the bidirectional performance information associated with any pairs including the computing node.

In some embodiments, the computer instructions, when executed by the processing circuitry, perform operations further comprising: applying a temporal stability criterion to the quantified degree of peer-relative performance deviation associated with a respective pair of computing nodes prior to encoding the machine-readable node pair deviation state, wherein: applying the temporal stability criterion includes evaluating peer-relative performance deviations of the respective pair of computing nodes across a plurality of assessment intervals; the respective pair of computing nodes is designated as exhibiting peer-relative conformance when the quantified degree of peer-relative performance deviation satisfies the performance deviation threshold for below a threshold quantity of assessment intervals; and the respective pair of computing nodes is designated as exhibiting peer-relative underperformance when the quantified degree of peer-relative performance deviation satisfies the performance deviation threshold for above or at the threshold quantity of assessment intervals.

In some embodiments, a computer-program product for peer-relative performance management in a cluster of computing nodes may store computer instructions that, when executed by processing circuitry, perform operations comprising: accessing computing node pair health testing data associated with a peer group of the cluster of computing nodes; deriving, for each of two or more pairs of computing nodes of the peer group, bidirectional performance information characterizing a performance of the respective pair of computing nodes; computing a peer-relative performance distribution across the peer group of computing nodes based on the derived bidirectional performance information; automatically generating, for each pair of computing nodes of the two or more pairs, a machine-readable node pair deviation state, wherein automatically generating the machine-readable node pair deviation state for a pair of computing nodes comprises: computing a quantified degree of peer-relative performance deviation for the pair based on the respective bidirectional performance information and the peer-relative performance distribution; determining whether the quantified degree of peer-relative performance deviation for the pair satisfies a performance deviation threshold; encoding, within the node pair deviation state, an indication that the respective pair exhibits peer-relative underperformance when the quantified degree of peer-relative performance deviation satisfies the performance deviation threshold; and encoding, within the node pair deviation state, an indication that the respective pair exhibits peer-relative conformance when the quantified degree of peer-relative performance deviation fails to satisfy the performance deviation threshold; automatically rendering an interactive cluster performance visualization artifact comprising a plurality of node pair representations corresponding to the peer group, wherein each node pair representation is encoded with visual attributes indicating the machine-readable node pair deviation state of the respective pair of computing nodes; receiving, via a graphical user interface rendering the interactive cluster performance visualization artifact, a user input selecting a computing node with at least one node pair representation whose visual attributes indicate that the computing node is included in a pair exhibiting peer-relative underperformance; in response to receiving the user input, initiating one or more corrective operations affecting the selected computing node.

In some embodiments, encoding the visual attributes for a respective computing nodes includes: mapping the quantified degree of peer-relative performance deviation for the computing node to one or more of a color value, a color intensity, a heatmap value, a graphical marker size, or a graphical annotation associated with the node pair representation, such that pairs of computing nodes exhibiting peer-relative conformance and pairs of computing nodes exhibiting peer-relative underperformance are visually distinguishable within the interactive cluster performance visualization artifact.

In some embodiments, automatically generating the machine-readable node pair deviation state for the pair of computing nodes further comprises: determining whether the quantified degree of peer-relative performance deviation satisfies a second performance deviation threshold, wherein: encoding the indication that the respective pair exhibits peer-relative underperformance occurs when the quantified degree of peer-relative performance deviation satisfies the performance deviation threshold and the second performance deviation threshold; and encoding the indication that the respective pair exhibits peer-relative conformance occurs when the quantified degree of peer-relative performance deviation fails to satisfy both the performance deviation threshold and the second performance deviation threshold; and encoding, within the machine-readable node pair deviation state, an indication that the respective pair exhibits an intermediate degree of peer-relative performance when the quantified degree of peer-relative performance deviation satisfies the second performance deviation threshold and fails to satisfy the performance deviation threshold, wherein a corresponding node pair representation includes visual attributes indicating that the pair exhibits the intermediate degree of peer-relative performance when the machine-readable node pair deviation state is encoded with the intermediate degree of peer-relative performance.

In some embodiments, generating the interactive cluster performance visualization artifact further includes: automatically determining one or more visualization bounds based on the peer-relative performance distribution; scaling at least one axis or color range of the visualization artifact based on the determined visualization bounds, wherein scaling the visualization artifact enables detection and visual differentiation of pairs of computing nodes exhibiting peer-relative conformance and pairs of computing nodes exhibiting peer-relative underperformance.

In some embodiments, the computer instructions, when executed by the processing circuitry, perform operations further comprising: dynamically updating the interactive cluster performance visualization artifact in response to updates to machine-readable node pair deviation states, wherein dynamically updating the interactive cluster performance visualization artifact comprises: automatically detecting execution of additional computing node health tests associated with one or more computing nodes of the peer group; updating the machine-readable node pair deviation states based on results of the additional computing node health tests; and propagating the updated machine-readable node pair deviation states to modify corresponding node pair representations within the interactive cluster performance visualization artifact, thereby enabling the interactive cluster performance visualization artifact to be reflect whether a pair of computing nodes is exhibiting peer-relative underperformance in near-real-time.

In some embodiments, the one or more corrective operations comprises one or more of: re-testing of the identified computing node; modifying a workload eligibility of the identified computing node; or transitioning the identified computing node to a restricted or quarantine operational state within the cluster of computing nodes.

In some embodiments, the computer instructions, when executed by the processing circuitry, perform operations further comprising: receiving, via the graphical user interface rendering the interactive cluster performance visualization artifact, a user input selecting computing nodes sharing a common machine-readable node pair deviation state; and in response to receiving the user input, automatically generating or modifying a logical resource grouping within the cluster of computing nodes by assigning the selected computing nodes to a designated operational partition, resource pool, or scheduling domain based on the shared machine-readable node pair deviation state.

In some embodiments, a method for peer-relative performance management in a computing cluster may comprise a cluster performance insight interface in operable command communication with an administrative computing node of the cluster of computing nodes; accessing, via the cluster performance insight interface, computing node pair health testing data associated with a peer group of the cluster of computing nodes; deriving, for each of two or more pairs of computing nodes of the peer group, bidirectional performance information characterizing a performance of the respective pair of computing nodes; computing a peer-relative performance distribution across the peer group of computing nodes based on the derived bidirectional performance information; automatically generating, for each pair of computing nodes of the two or more pairs, a machine-readable node pair deviation state, wherein automatically generating the machine-readable node pair deviation state for a pair of computing nodes comprises: computing a quantified degree of peer-relative performance deviation for the pair based on the respective bidirectional performance information and the peer-relative performance distribution; determining whether the quantified degree of peer-relative performance deviation for the pair satisfies a performance deviation threshold; encoding, within the node pair deviation state, an indication that the respective pair exhibits peer-relative underperformance based on the quantified degree of peer-relative performance deviation satisfying the performance deviation threshold; and exposing the machine-readable node pair deviation states, wherein the machine-readable node pair deviation states are consumable data signals by one or more cluster management interfaces supporting operational control of workload placement and resource utilization within the cluster of computing nodes.

### BRIEF DESCRIPTION OF THE FIGURES

FIG. 1 illustrates a schematic representation of a system in accordance with one or more embodiments of the present application;

FIG. 2 illustrates an example method in accordance with one or more embodiments of the present application;

FIG. 3 illustrates an example of homogeneous node identification in accordance with one or more embodiments of the present application;

FIG. 4 illustrates an example implementing a testing cycle of a node health test subject to n−1 testing in accordance with one or more embodiments of the present application;

FIG. 5 illustrates an example of a delineation of likely healthy and likely unhealthy node pairings in accordance with one or more embodiments of the present application;

FIG. 6 illustrates an example of deducing a likely unhealthy node based on a common denomination of a node in accordance with one or more embodiments of the present application;

FIG. 7 illustrates an example of identifying likely unhealthy nodes or likely healthy nodes based on ranking node pairings and applying a benchmark in accordance with one or more embodiments of the present application;

FIGS. 8A and 8B illustrate schematic representations for peer-relative performance evaluation and adaptive cluster management in accordance with one or more embodiments of the present application;

FIG. 9 illustrates an example method for peer-relative performance evaluation and adaptive cluster management in accordance with one or more embodiments of the present application;

FIG. 10 illustrates a node pair deviation state detection schematic representation in accordance with one or more embodiments of the present application;

FIG. 11 illustrates a node deviation state generation schematic representation in accordance with one or more embodiments of the present application;

FIGS. 12A and 12B illustrate a node pair performance information extraction procedure in accordance with one or more embodiments of the present application;

FIG. 13 illustrates a node deviation state generation procedure in accordance with one or more embodiments of the present application;

FIGS. 14 and 15 illustrate an interactive visualization generation schematic representations in accordance with one or more embodiments of the present application;

FIGS. 16A and 16B illustrate performance health map views in accordance with one or more embodiments of the present application; and

FIGS. 17A and 17B illustrate performance health map views in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Enhanced Cluster Health Management and Unhealthy Node Detection

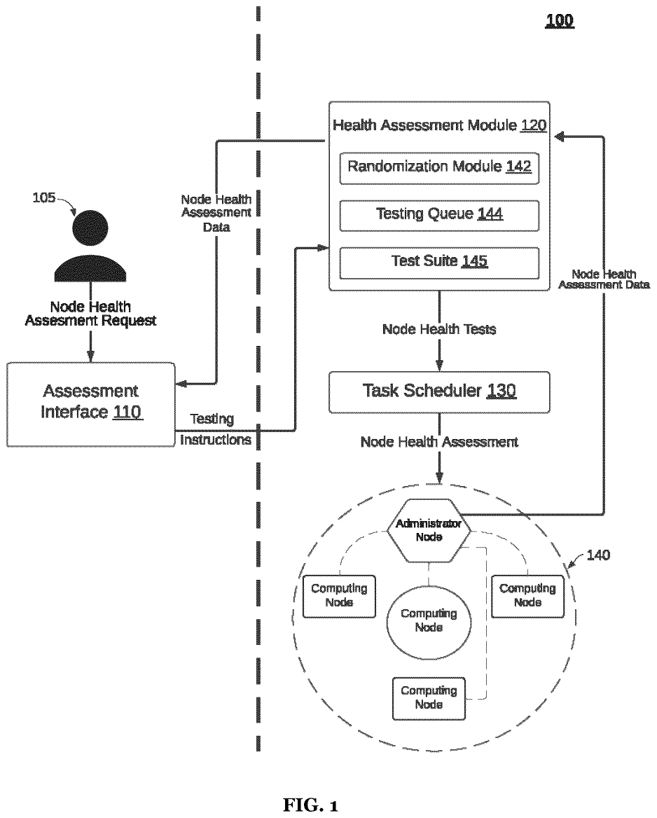

As shown in FIG. 1, a system 100 implementing enhanced cluster health management and for detecting unhealthy computing nodes within a cluster of computer nodes includes a node health assessment interface 110, a health assessment module 120, and a task scheduler 130 for assessing the health of a cluster of computing nodes 140.

### 1.1 Computing Node Health Assessment Interface

The node health assessment interface 110, which may also be referred to herein as assessment interface 110, preferably includes a command interface or system programming interface or console through which an administrator 105 may operate to execute a node health assessment of a target cluster of computing nodes 140. In a preferred embodiment, the assessment interface 110 is preferably implemented by one or more computers and may be in operable control communication with one or more computing nodes of a target cluster of computing systems. In such preferred embodiment, the assessment interface 110 may function to receive, as input, one or more user commands for executing one or more aspects of a node health assessment of a target cluster of computing nodes 140 and output control signals to the one or more computing nodes of the target cluster of computing nodes 140.

In one or more embodiments, the one or more computing nodes of a target cluster of computing nodes 140 that may be operably controlled via the assessment interface 110 preferably include an administrator node. In such embodiments, the administrator node comprises one computing node of the target cluster of computing nodes 140 that may be in network communication with all computing nodes of the target cluster of computing nodes 140. The administrator node executing commands or instructions from the assessment interface 110 may function to administer any suitable tests to the target cluster of computing nodes 140 including, but not limited to, a node health assessment. In some embodiments, the administrator node may be referred to herein as a head node or a control node depending on its operation within the cluster of computing nodes 140. Accordingly, the administrator node 105 may have installed cluster management software or similar applications that preferably enables the administrator node 105 to coordinate activities of the cluster of computing nodes 140, manage resource allocation, perform scheduling (e.g., integrated scheduler 130), and/or support maintaining an overall health of the cluster of computing nodes 140.

Additionally, or alternatively, the administrative node may be in operable control communication of a parallel file system or the like for administering any suitable tests, including a node health assessment, to a target cluster of computing nodes 140. Additionally, or alternatively, the administrative node may include an assessment agent installed thereon that may be in communication and operably controlled via commands from the assessment interface 110. In some embodiments, the assessment agent of the administrator node based on command inputs from the assessment interface 110 may function to automatically execute one or more operations or functions of a node health assessment against a target cluster of computing nodes 140.

### 1.2 Health Assessment Module

The health assessment module 120, in one or more embodiments, which is in operable communication with one or more of the assessment interface 110, the node assessment scheduler 130, and cluster of computing nodes 140 may operate to configure one or more node health assessments and/or execute one or more node health assessments against a target set of computing nodes of the cluster of computing nodes 140. In one or more embodiments, the health assessment module 120 may function to store and/or have access to a test suite 145, which is sometimes referred to herein as a pool of node health tests, that includes a plurality of node health tests. At runtime, the health assessment module 120 may function to source from the test suite 145 one or more node health tests, which may be executed either serially or in parallel against computing nodes of the cluster of computing nodes 140.

In one or more embodiments, the health assessment module 120 may be implemented in cooperation with a network file system, a parallel file system or the like. In such embodiments, the health assessment module 120 may be implemented by an administrative computing node of a target cluster of computing nodes, the administrative computing node may be sometimes referred to herein as a “head node” or “node zero”. Additionally, or alternatively, each computing node in the target cluster of computing nodes may store a copy of the tests and/or assessments associated with an operation of the health assessment module 120. In this way, commands and/or signals from the health assessment module 120 may cause any or each of the computing nodes of the target cluster to access one or more tests and/or assessments and execute the tests or assessments concurrently. In such embodiments, the outputs of the execution of the tests and/or assessments by the target cluster of computing nodes may be stored to or served out to the network file system.

Additionally, or alternatively, the health assessment module 120 may function to implement and/or include one or more of a randomization module 142 and a testing queue 144 that may operate together for initializing and executing a node health assessment of computing nodes of a cluster of computing nodes 140. In one or more embodiments, the randomization module 142 may function to ensure that different first computing nodes are seeded to prevent biased results on the basis of an initial computing node selection from a batch of computing nodes subject to a node health assessment.

### 1.3 Automated Task Scheduler

The task scheduler 130 preferably functions as an orchestration layer that automatically facilitates a node health assessment. In a preferred embodiment, the task scheduler 130 may function to integrate node health assessments directly into an operational workflow of the cluster of computing nodes 140. Accordingly, the task scheduler 130 may be multi-faceted in its automated application of node health assessments on a predetermined schedule or dynamically during a pre-job deployment of a batch of computing nodes.

In one or more embodiments, the task scheduler 130 may function to continually and/or periodically monitor a state of computing nodes within the cluster of computing nodes 140 to identify idle computing nodes that are not currently allocated to user jobs. In such embodiments, the task scheduler 130 may batch the idle computing nodes to the node testing queue 144 for a node health assessment.

### 1.4 Cluster of Computing Nodes

The cluster of computing nodes 140 preferably includes a plurality of distinct computing nodes where each distinct node comprises a computer. In a preferred embodiment, the computer typically includes a server-grade machine, equipped with one or more of central processing units (CPUs), graphical processing units (GPUs), both, or similar processing components capable of executing tasks and running applications. In one or more embodiments, the plurality of distinct computing nodes in a cluster may include network interconnects comprising high-speed communication pathways that link the computing nodes together, facilitating rapid data transfer. One or more examples of network interconnects may include, but should not be limited to, InfiniBand, Ethernet, fiber-optic connections that may enable the computing nodes to operate in concert for distributed computing tasks.

Additionally, or alternatively, a cluster of computing nodes may include a storage system having an associated memory or data storage solutions that may range from local disk drives within each computing node of the cluster of computing nodes 140 to shared storage systems, such as storage area network (SAN) or network attached storage (NAS), accessible by all computing nodes in cluster 140 for distributed file systems and data persistence. In a preferred embodiment, the cluster of computing nodes 140 preferably employs a parallel file system that allows multiple computing nodes to access and process data simultaneously, which may increase throughput and efficiencies of the computing nodes.

### 2. Method for Enhanced Cluster Health Management and Unhealthy Node Detection

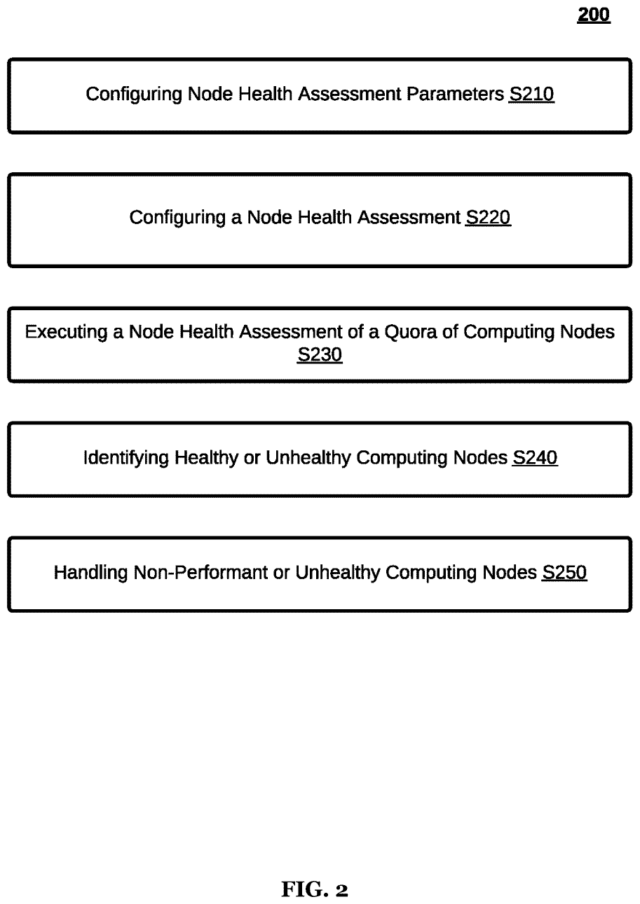

As shown in FIG. 2, a method 200 implementing enhanced cluster health management and for detecting unhealthy computing nodes within a cluster of computer nodes includes configuring a health assessment for a set of computing nodes S210, executing a health assessment for the set of computing nodes S220, identifying health assessment observations of the set of computing nodes S230, and mitigating unhealthy nodes from a cluster of computing nodes S240, and handling non-performant or unhealthy computing nodes S250.

The method 200 as implemented by one or more systems (e.g., system 100) preferably provides a scalable solution for monitoring and maintaining the health of computing clusters by detecting un-reported technical issues. In particular, the method 200 in various embodiments functions to systematically identify underperforming computing nodes and/or components and thereby aids in a prevention of performance degradation and further extends a reliable operation of the hardware of a cluster of computing nodes.

### 2.10 Node Health Assessment Configuration

S210, which includes configuring or setting one or more node health assessment parameters, may function to define via assessment interface 110 or the like parameters for testing the operational health of a set of computing nodes within a cluster of computing nodes. In one or more embodiments, the one or more node health assessment parameters may function to define one or more conditions and/or one or more bounds that govern an operation and/or execution of a given node health assessment of a cluster of computing nodes.

In one or more embodiments, configuring or setting the one or more node health assessment parameters may include defining or setting criteria of a basis block unit. A basis block unit, as referred to herein, preferably relates to a minimum chunk of an allocatable computing resource for testing collectives. In the case of performing health assessment tests for a cluster of computing nodes, a basis block unit may be defined by three or more available computing nodes within a cluster of computing nodes. Additionally, or alternatively, in the case of performing health assessment tests of computing components, a basis block may similarly be a minimum of three or more allocatable computing components (e.g., graphic processing units, networking cards, etc.) that are accessible and available for collective testing.

Additionally, or alternatively, in some embodiments, a basis block unit may be a fundamental computing unit or node that is sufficiently healthy for performing fundamental and/or desired computing and/or interconnect tasks. It shall be recognized that a basis block unit may be defined in any suitable manner that considers operational fault tolerances and/or minimum performance requirements such that a basis block unit may include an amount of non-performant components but may still satisfy criteria for a given basis block unit.

Accordingly, in operation, a system (e.g., system 100 or a service) implementing method 200 may function to receive, as input, a specification data for defining a basis block unit. In such embodiments, once the specification data is received, the method 200 and/or the system executing the method 200 encodes or sets a basis block unit as an initialization parameter of a given node health assessment.

In one or more embodiments, configuring or setting the one or more node health assessment parameters may include defining or setting an extent of a node health assessment. In such embodiment, S210 may function to define or set a value of an upper limit parameter that sets a largest size of a node health assessment. That is, the upper limit parameter may define a maximum number of computing nodes that may be assessed or tested during a given session of a node health assessment. In operation, an arbitrary number of nodes may be testable or assessed via a node health assessment, however, a delimitation of an upper limit or maximum number of testable nodes may ensure an availability of computing nodes for executing jobs and/or various computing tasks. As a non-limiting example, a maximum number of computing nodes that may be tested at a given time or during a given node health assessment may be limited to ten (10) or twenty (20) basis block units. In such non-limiting example, if the upper limit of testable basis block units is 20, the given node health assessment may function to cap a node testing such that a quora of testable nodes of a cluster of computing nodes may include less than the upper limit parameter but not exceed the upper limit parameter.

Additionally, or alternatively, configuring or setting the one or more node health assessment parameters may include selecting a suite of tests or assessments to apply in the node health assessment of target computing nodes in a cluster of computing nodes. In one or more embodiments, S210 may enable a selection of a suite of tests from a pool of pre-existing tests and/or test scripts. In such embodiments, the selection of one or more tests from the pool of tests that define the suite of tests may be based on attributes (e.g., node model, hardware type, hardware components, and the like) of the target computing nodes subject to the node health assessment. In a variation of this embodiment, S210 may enable a custom creation of test scripts or node health tests, which may be added in the suite of tests for execution in the node health assessment.

Additionally, or alternatively, S210 may function to configure an application of the suite of tests during the node health assessment. In one or more embodiments, based on test application parameters, S210 may function to execute node health assessments across a plurality of computing nodes in parallel and/or in tandem. That is, in a parallel application of a node health assessment, a same suite of tests may be applied to a set of computing nodes at the same time or substantially the same time thereby allowing for a scaled and accelerated evaluation of multiple computing nodes. As such, at least one technical advantage of such embodiments includes improved efficiency in an evaluation of many computing nodes allowing for a detection of an unhealthy node faster than existing testing mechanisms.

### 2.20 Node Health Assessment: Configuration Phase

S220, which includes executing a node health assessment of a set of (or target) computing nodes of a given cluster of computing nodes. In a preferred embodiment, the execution of the node health assessment of the set of computing nodes may be based on or informed by the one or more node health assessment parameters, as described in S210. Additionally, or alternatively, executing a node health assessment may be considered as a multi-part implementation in which an initialization and/or a configuration of one or more modules or testing components of a node health assessment may be performed in a first phase and an execution of the tests of the node health assessment may be performed in a second phase. It shall be recognized that while, in some embodiments, a node health assessment may be implemented in multiple parts or multiple phases, in other embodiments, the node health assessment may be contiguously implemented in a single phase.

Accordingly, a node health assessment for a set of computing nodes may be based on a combination of predefined and dynamic criteria. In one or more embodiments, the predefined criteria may include manufacturer specifications and past performance logs, while dynamic criteria could involve real-time workload demands and network activity. Thus, the assessment configuration phase, as described herein, preferably allows for the tailoring of node health assessments to the specific architecture and use cases of the cluster of computing nodes thereby enhancing the precision of the detection process of unhealthy or non-performant computing nodes.

### Assessment Configuration Phase: Idle Computing Nodes

In one or more embodiments, executing the node health assessment may include an initial phase that may include identifying a set of testable computing nodes of a target cluster of computing nodes. A target cluster of computing nodes may, in some embodiments, include a combination of active computing nodes and idle computing nodes. In a preferred embodiment, S220 may function to identify, as testable computing nodes, the idle computing nodes of the target cluster of computing nodes and, optionally, select at least a subset of the idle computing nodes for testing via the node health assessment. In this preferred embodiment, S220 may function to select idle computing nodes which preferably relate to computing nodes without impending computing jobs, user jobs, and/or interconnect tasks. In this way, a testing of a currently idle set of computing nodes may not interfere with one or more computing jobs and/or interconnect tasks intended for the idle computing nodes at a future time or interfere with active jobs being executed by active computing nodes of the target cluster of computing nodes.

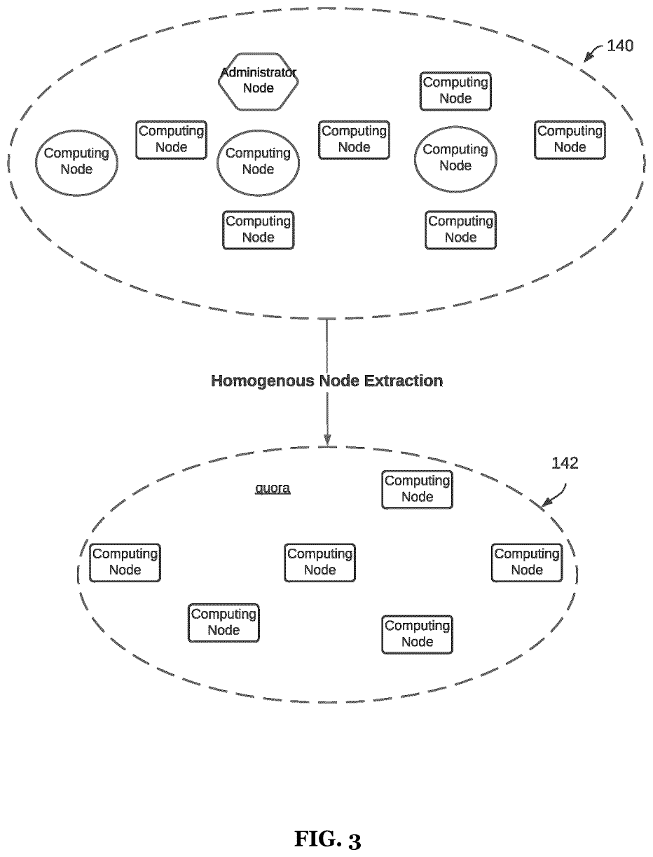

In a preferred embodiment, S220 may function to select from the set of idle computing nodes only the idle computing nodes that may be homogeneous (e.g., same model server or same components) rather than heterogeneous, as shown by way of example in FIG. 3. Because the set of idle computing nodes may include computing nodes having heterogeneous structures and/or compositions (e.g., varying interconnect/networking bands, varying processing units, etc.), S220 preferably selects for inclusion in a batch for a node health assessment only idle computing nodes that may be homogeneous in type, structures and/or compositions. In such embodiments, the homogeneity of the idle computing nodes being evaluated in a given node health assessment ensures valid collective testing, which may include point-to-point, peer-to-peer testing and/or similar testings. That is, in a given node health assessment that includes a pool or suite of tests or testing scripts, heterogeneous computing nodes may theoretically execute the suite of tests differently in peer-to-peer testing thereby causing an inability to compute valid results in the peer-to-peer comparisons. Conversely, homogeneous computing nodes executing a same pool of tests should behave similarly, assuming the computing nodes are not errant or otherwise non-performant for one or more reasons relating to the operability of their hardware and/or software components.

It shall be recognized that while in preferred embodiments, homogeneous computing nodes may be grouped into a batch for a node health assessment, in other embodiments, heterogeneous computing nodes may also be grouped for a node health assessment. In such other embodiments, a group of heterogeneous computing nodes may include one or more components that may be homogeneous among the heterogeneous computing nodes in the group. Accordingly, in such variation, S220 may enable a node health assessment on the basis of evaluating homogeneous components (e.g., same model GPUs) within a group of heterogeneous computing nodes.

### Assessment Configuration Phase: Node Testing Queue

Additionally, or alternatively, once a set of idle computing nodes may be identified as likely candidates for a node health assessment, S220 may function to reserve the set of idle computing nodes for collective testing by grouping at least a subset of the idle computing nodes into a node testing queue 144 or the like. In one or more embodiments, once the group or set of idle computing nodes are moved into a reserved state in which the idle computing nodes are set aside for testing, the group of idle computing nodes may be referred to as a group of reserved computing nodes since during a testing phase the computing nodes become active and are no longer idle during an execution of one or more tests by computing nodes within the group of reserved computing nodes. Conversely, upon completion of a node health assessment of the group of reserved computing nodes, the method 200 may function to revert or alter the state of the group of reserved computing nodes to idle computing nodes by moving the computing nodes from the node testing queue 144 to a queue for idle computing nodes. The node testing queue 144, as referred to herein, preferably refers to a dedicated virtual space and/or memory in which idle computing nodes that have been selected and/or marked for testing may be itemized or enumerated by one or more unique identifiers of the selected idle computing nodes and made available for various testings via the node health assessment. Accordingly, in or more embodiments, the node testing queue 144 may function as a mechanism for orchestrating a given node health assessment of a target set of computing nodes within a cluster of computing nodes 140.

In a preferred embodiment, S220 may function to ensure that a sufficient number of idle computing nodes are added to the node testing queue 144 satisfying a lower bound parameter and/or lower limit parameter/threshold identifying a minimum number of computing nodes that should be tested in a given node health assessment. In such preferred embodiment, the node testing queue 144 is populated with a set of idle computing nodes selected from a target cluster of computing nodes 140, preferably employing a randomization algorithm preventing bias in a selection process of the population of idle computing nodes. The randomization algorithm preferably ensures varied starting or seeding nodes for each test sequence thereby mitigating the risk of consistent underperformance from any single computing node that may skew the results of a node health assessment. For instance, in some embodiments, a node health assessment test may be benchmarked against an initial peer-to-peer testing between two computing nodes, which may be seeded with a non-performant computing node. In such embodiments, the resulting performance data if propagated as a benchmark for downstream testing of other computing nodes may unfavorably skew testing results such that other non-performant computing nodes may not be detected due to using a benchmark having degraded performance results.

Additionally, or alternatively, S220 may function to ensure that a number of computing nodes added to the node testing queue 144 does not exceed an upper limit parameter identifying a maximum number of computing nodes that should be tested in a given node health assessment. In this way, an availability of computing nodes with a target cluster of computing nodes 140 may be preserved for potential computing jobs and/or networking tasks.

### Assessment Configuration Phase: N−1 Drop Out Testing

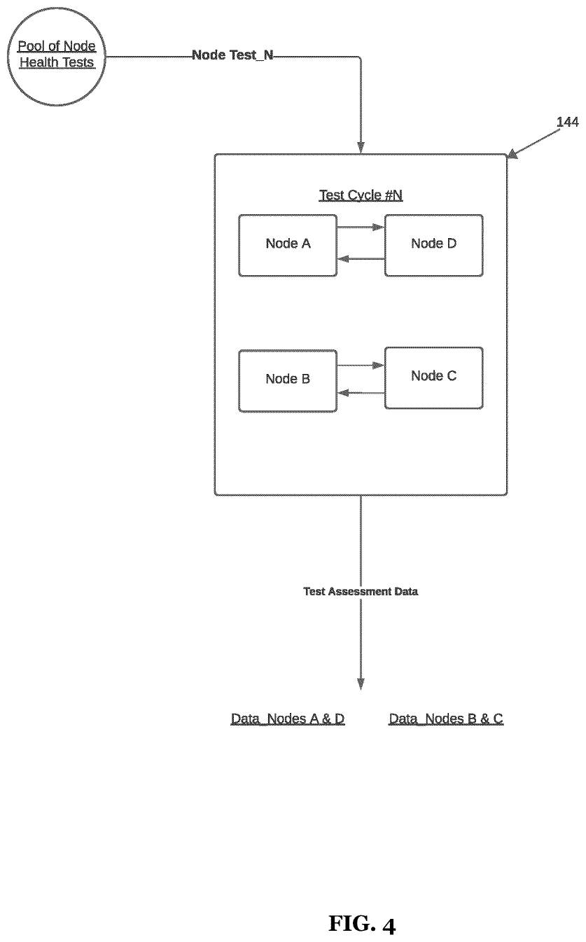

Additionally, or alternatively, S220 may function to configure the node testing queue 144 according to n−1 testing. In one or more embodiments, S220 may function to subject the node testing queue 144 to n−1 testing which governs a bi-directional assessment between pairs of idle computing nodes assigned to the node testing queue 144, as shown by way of example in FIG. 4. In such embodiments, “n” preferably represents the number of idle computing nodes or computing node components that may be grouped or batched into the node testing queue 144 and accordingly, when the node testing queue 144 is subjected to n−1 testing preferably causes the node testing queue 144 and/or a node health assessment module to generate a plurality of distinct testing combinations that include possible paired combinations of the idle computing nodes within the node testing queue 144 while excluding at least one idle computing node or a paired combination of idle computing nodes within the node testing queue 144. Accordingly, in one or more embodiments, the term “n” may represent a total number of nodes in a batch or group of idle computing nodes being considered for a node health assessment test assigned to a node testing queue 144. Stated differently, during n−1 testing, a given idle computing node or a given paired combination of idle computing nodes may be systematically excluded in each test iteration to determine an impact of the given idle computing node or the given paired combination of computing nodes on an overall performance of batch of idle computing nodes within the node testing queue 144.

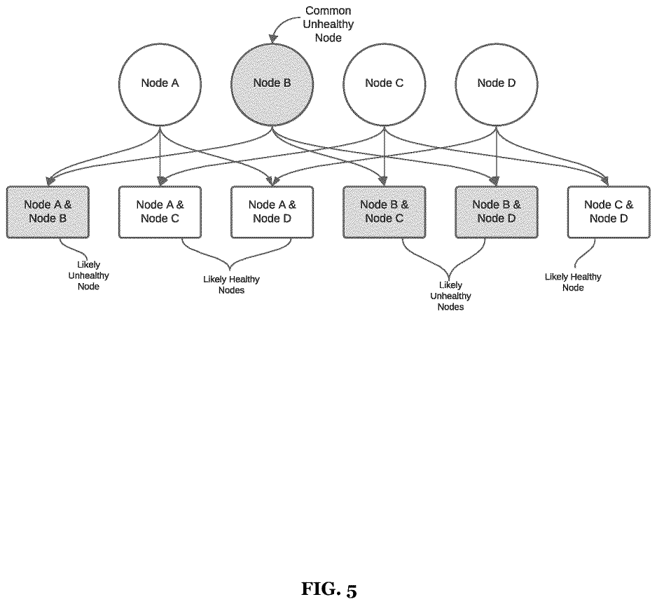

As a non-limiting example, a group of “n” idle computing nodes may be identified or selected for testing. In this example, the group of idle computing nodes may include Node A, Node B, Node C, and Node D selected from a cluster of computing nodes 140 and populated as a batch assigned to a node testing queue 144 that may be subject to n−1 testing. As shown by way of example in FIG. 5, a total of six (6) distinct paired combination of idle computing nodes may be delineated (i.e., Nodes A & B, Nodes A & C, Nodes A & D, Nodes B & C, Nodes B & D, and Nodes C & D) for the node health assessment. Accordingly, in this example, because there are 6 paired combinations of idle computing nodes, a total of 6 testing cycles may be executed, which may exclude or drop out a different paired combination of idle computing nodes in each cycle.

Accordingly, in one or more embodiments, the n−1 testing configuration of the node testing queue 144 enables a system or service executing the node health assessment to systematically identify faulty or likely faulty computing nodes within a batch by systematically excluding a given computing node or pair of computing nodes during an instance of testing and thereby exclude or drop out (from subsequent testing cycles) each faulty node at a time while allowing the computing nodes remaining the batch to potentially accumulate as performant or good basis block units. Additionally, or alternatively, S220 may function to configure batch sizes of the computing nodes to mitigate seeding a node health assessment with values from a faulty computing node or the like. By setting the batch sizes of (idle) computing nodes to relatively small numbers, benchmarking with testing values from a faulty computing node may only affect an assessment of only a limited number of other computing nodes within the small batch.

### 2.30 Node Health Assessment: Assessment Execution Phase

S230, which includes executing a node health assessment, may function to execute collective testing, which may include point-to-point, peer-to-peer testing and/or similar testings of a quora of computing nodes enabling a detection of non-performant computing nodes (e.g., drop out) from the quora and a maintenance of performant computing nodes (e.g., accumulation) within the quora. Accordingly, based on the configuration of a node health assessment in one or more embodiments, the node health assessments may be executed by sending diagnostic commands from an administrator node 105 or the like to each computing node of the quora. In such embodiments, command signals may prompt the quora of computing nodes to perform bi-directional tests and self-tests and report back to the administrator node 105. The execution phase of a node health assessment may be optimized by the node health assessment parameters to minimize performance disruptions, often scheduling the most resource-intensive tests during off-peak hours (e.g., times with the most idle computing nodes).

### Scaled Node Health Assessment

In a first implementation, S230 may function to execute a scaled execution of a given node health assessment. In this first implementation, if a number of idle computing nodes that may be a target of a given node health assessment satisfies or exceeds a scaled assessment threshold, S230 may function to execute the given node health assessment of one or more batches of the idle computing nodes by subjecting the node testing queue 144 to n−1 testing. The scaled assessment threshold preferably relates to a maximum number of computing nodes that may typically be tested using a different testing technique for lower volume of test subjects, such as pairwise testing.

In one or more embodiments of this first implementation, S230 may function to execute bi-directional testing of paired combinations of idle computing nodes within a node testing queue 144. The bi-directional testing, as referred to herein, preferably includes a testing mechanism that measures the performance between pairs of computing nodes by causing a given pair of computing nodes to execute one or more tests of a node health assessment via data transmissions to each other and/or processing operations between each other. In such embodiments, by testing in both directions of a paired combination of idle computing nodes, bi-directional testing simulates a likely real-world usage with higher accuracy than unidirectional testing thereby providing an improved assessment of how the paired combination of idle computing nodes may perform under normal or real-world operating circumstances.

Accordingly, in circumstances in which the health of network interconnects may be important for the performance of processing components (e.g., GPUs, CPUs, etc.) of a target cluster of computing nodes 140, bi-directional testing may ensure that fiber-optic networks and associated networking components (e.g., network cards) used to connect processing components (e.g., GPU servers) are capable of operating peak performance of high-speed, two-way data transmission.

In one or more embodiments, each paired combination of idle computing nodes may be bi-directionally tested for performance according to one or more standardized and/or node health tests that may be selected from a pool of node health tests. In one or more embodiments in which the node health assessment includes a plurality of distinct node health tests, S230 may function to execute one or more of the plurality of distinct node health tests serially and/or in a parallel manner. In the one or more embodiments in which the pool of node health tests may be executed serially, S220 may function to derive or define a testing sequence in which the plurality of node health tests may be arranged in an order in which the node health tests will be executed, such that when a given node health test within the testing sequence is completed, a node health test following the given node health test may be automatically executed against the batch of idle computing nodes.

Conversely, or additionally, in one or more embodiments, the pool of node health tests of a node health assessment may be executed in parallel such that a given paired combination of idle computing nodes may be subject to multiple node health tests at the same time; that is, two or more node health tests may be applied to a paired combination of idle computing nodes at the same time. In such embodiments, the two or more node health tests applied against a paired combination of idle computing nodes may be applied against different components of the paired combination of idle computing nodes. As a non-limiting example, a first node health test of a set of node health tests being applied in a parallel manner against a paired combination of idle computing nodes may function to test a networking component (e.g., networking cards) while a second node health test operates to test a processing component (e.g., GPUs) of the paired combination of idle computing nodes.

### Pairwise Accumulation and Drop out

In a second implementation, idle computing nodes added to a node testing queue 144 may be subject to pairwise testing via a node health assessment. In one or more embodiments, if a number or scale of computing nodes that may be targets for a node health assessment does not satisfy a node testing threshold (i.e., a minimum of three computing nodes, minimum of three homogeneous node components, and the like), S220 may function to enable simple pairwise testing of the target idle computing nodes within a batch. In such embodiments, S220 may function to bi-directionally test distinct pairs of idle computing nodes on a pair-by-pair basis (e.g., one pair at a time) to identify non-performant computing nodes.

### 2.40 Health Assessment Data & Metrics|Unhealthy Node Detection

S240, which includes detecting an unhealthy computing node, may function to collect or source node performance metrics and/or observations from an execution of a given node health assessment and preferably, deduce non-performant (e.g., unhealthy) and/or performant (e.g., healthy) computing nodes based on analysis of the node performance metrics and/or observations.

In one or more embodiments, the observations data and/or node performance metrics resulting or derived from an execution of one or more node health assessments may be categorized into various levels of severity or into a hierarchy of severity. In such embodiments, a real-time or near real-time analysis of the observations data trigger immediate responses for bypassing one or more intermediate node health assessment actions or processes (e.g., node health verification or the like) and accelerating mitigation actions that may ameliorate any degradative effects of an unhealthy node. Accordingly, the system executing the method 200 may be configured to differentiate between transient issues and persistent problems within a cluster of computing nodes 140 that could signify an unhealthy computing node.

In one or more embodiments, S240 may function to obtain or derive one or more node testing data metrics relating to, but not limited to, throughput metrics, bandwidth metrics, latency metrics, error rates in a transmission of data, and/or any derivable metric measuring an efficacy or other performance attributes of a target set of computing nodes. Accordingly, as computing nodes of a target batch of computing nodes are being tested, S240 may function to collect summary statistics and/or metrics for each paired combination of idle computing nodes thereby enabling the method 200 to determine which computing nodes should be made available for user jobs and which should be subjected to further testing and/or maintenance and repair.

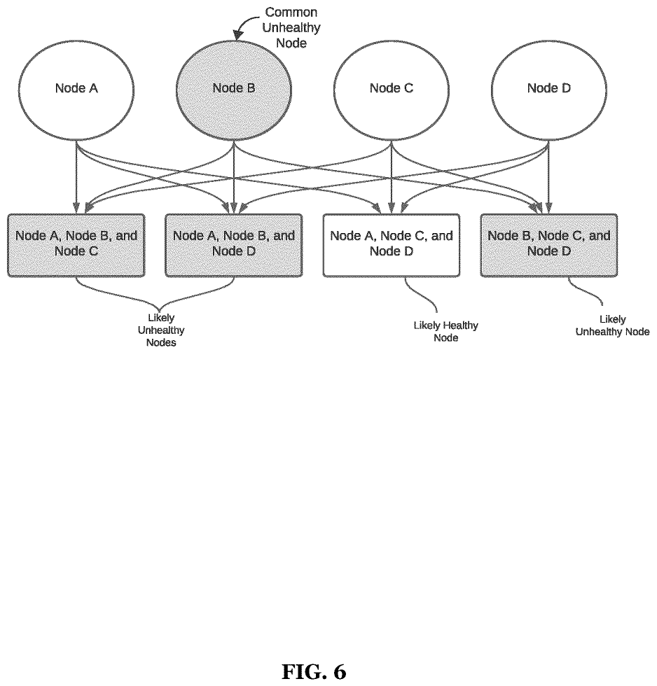

In a first implementation, S240 may function to identify or detect non-performant computing nodes based on deducing a likely faulty computing node based on performance metrics collected during each of a plurality of cycles of an n−1 testing of a batch of idle computing nodes. In this first implementation, S240 may function to identify non-performant paired combinations of idle computing nodes from each cycle of the n-l testing of the batch. A non-performant paired combination of idle computing nodes preferably relates to a pairing whose metrics that does not satisfy a performance benchmark (e.g., minimum operating or normal operating metrics, or the like). S240 evaluating each testing cycle, may function to extract or identify groups of non-performant paired combinations of idle computing nodes in which one of the idle computing nodes is common to each non-performant paired combination of idle computing nodes. In such embodiments, S240 may generate an inference identifying the idle computing node that is common among the non-performant paired combination of idle computing node is likely a faulty or errant computing node, as shown by way of example in FIG. 6.

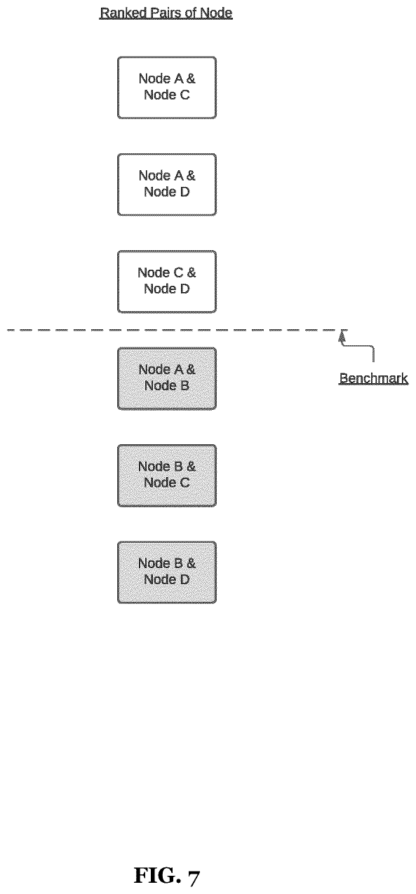

In a second implementation, S240 may function to identify or detect non-performant computing nodes based on ranking or ordering each paired combination of idle computing nodes based on test metric data (e.g., descending performance metrics). In this second implementation, S240 may function to generate a plurality of distinct rankings with each distinct ranking being based on a different metric. In one example, in each testing cycle of an n−1 testing, S240 may function to source an average data, a maximum, or a percentile data throughput value for each paired combination of idle computing nodes. In this example, S240 may function to rank the plurality of paired combinations of idle computing nodes based on its associated average data throughput value. As shown by way of example in FIG. 7, in one or more embodiments, S240 applying a performance benchmark, such as a data throughput benchmark, against a ranking of a plurality of paired combinations of idle computing nodes may function to identify the paired combinations satisfying or exceeding the performance benchmark as including performant computing nodes and the paired combinations not satisfying the performance benchmark as likely including one or more non-performant computing nodes.

Additionally, or alternatively, in some embodiments, S240 may function to generate one or more graphical illustrations based on the node performance metrics and/or observations in which likely non-performant paired combinations of idle computing nodes are delineated differently than performant paired combinations of idle computing nodes. Based on the one or more graphical illustrations, likely non-performant paired combinations of idle computing nodes may be selected and/or routed for determining the likely faulty computing node in each non-performant paired combination.

In one or more embodiments, data visualization tools may be integrated within the assessment interface 110, providing administrators with intuitive dashboards that display the health of the cluster of computing nodes 140 and/or any individual computing node within the cluster. In such embodiments, some examples of the graphical illustrations or visualizations may include heat maps delineating between unhealthy and healthy computing nodes using color differentiation, time-series graphs, and computing node interconnectivity diagrams thereby allowing for a quick identification of problematic computing nodes.

### 2.50 Accumulation and Drop Out|Unhealthy Node Triage

S250, which includes handling non-performant or unhealthy computing nodes, may function to accumulate performant nodes within a quora of computing nodes while excluding or removing non-performant computing nodes based on an assessment of the node health assessment data, as described in at least S240.

In one or more embodiments, if S240 identifies a computing node as likely being a faulty or non-performant computing node, S250 may function to implement one or more protocols that minimize a degradative impact of the non-performant computing node. In such embodiments, S250 may function to quarantine the non-performant computing node from the remaining computing nodes of a target cluster of computing nodes 140. The quarantining, in one or more embodiments, may include flagging or marking the non-performant node for maintenance and further changing a state of the non-performant computing node to be offline from a previous online state. In an offline state, the non-performant computing node may not be accessible for user jobs but may remain accessible for testing, maintenance, and/or repair. Additionally, or alternatively, S250 may function to re-route traffic away from a likely unhealthy computing node that may enable a continued assessment of the likely unhealthy computing node in an online state.

Additionally, or optionally, S250 which includes S255, may function to route any non-performant computing node for additional downstream testing including, but not limited to, testing for characterizing a likely fault of a given non-performant node.

### 3. Method for Peer-Relative Performance Evaluation and Adaptive Cluster Management

Large-scale computing clusters configured for high-performance computing environments typically operate under conditions in which all computing nodes satisfy predefined absolute benchmark thresholds. Under such conditions, conventional health monitoring frameworks may classify each computing node as operationally acceptable when measured performance metrics fall within predefined minimum and maximum limits. Compliance with such absolute performance criteria, however, may not ensure homogeneous peer-relative performance behavior among computing nodes participating in tightly coupled parallel workloads. For instance, performance asymmetries between computing nodes that individually satisfy absolute thresholds may introduce aggregate execution inefficiencies across distributed processing operations. Conventional monitoring system configured to detect computing node failure based on absolute performance criteria may fail to detect such inefficiencies.

To address such limitations, the disclosed system may evaluate computing node behavior on a peer-relative basis within a cluster of computing nodes, enabling detection of performance differences that may not be observable through monitoring absolute performance criteria alone. The system may characterize a performance deviation of each computing node relative to other computing nodes within a peer group and may generate control signals to one or more cluster management components that trigger the one or more cluster management components to perform corrective actions based on such performance deviations. For instance, the one or more cluster management components may exclude computing nodes exhibiting negative performance deviation from performance-sensitive (e.g., latency-sensitive, long-duration) distributed workloads.

Further, the system may provide an interactive visualization environment configured to expose peer-relative deviation patterns. Visual representations presented within the interactive visualization environment may reflect deviation patterns across the peer group in a manner that exposes relational structure among computing nodes that raw benchmark outputs alone may fail to readily indicate. The system may further support adaptive scaling mechanisms that enhance perceptibility of subtle deviation gradients within tightly clustered performance bands, thereby enabling identification of computing nodes exhibiting fractional performance deviation that may not trigger absolute threshold alerts.

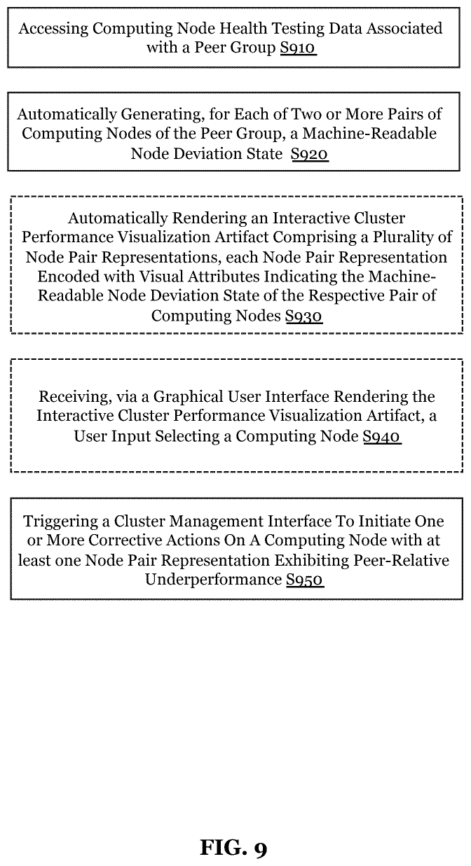

As shown in FIG. 9, a method 900 for peer-relative performance evaluation and adaptive cluster management within a cluster of computing nodes may include accessing computing node pair health testing data associated with a peer group S910; automatically generating, for each of two or more pairs of computing nodes of the peer group, a machine-readable node pair deviation state S920; automatically rendering an interactive cluster performance visualization artifact including a plurality of node pair representations, each node pair representation encoded with visual attributes indicating the machine-readable state of the respective pair of computing nodes S930; receiving, via a graphical user interface rendering the interactive cluster performance visualization artifact, a user input selecting a computing node S940, and triggering a cluster management interface to initiate one or more corrective actions on a computing node with at least one node pair representation exhibiting peer-relative underperformance S950.

### 3.1 Accessing Computing Node Health Testing Data Associated With a Peer Group

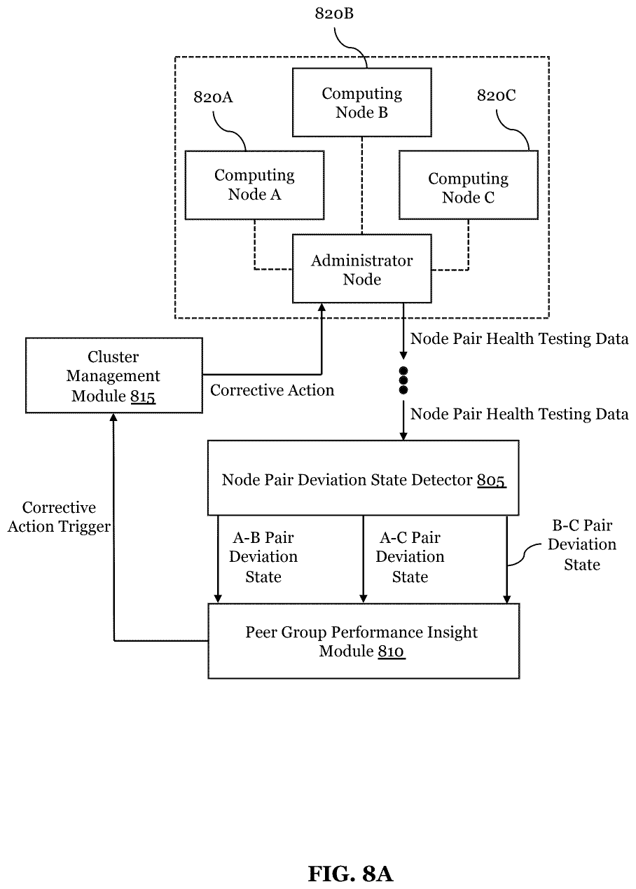

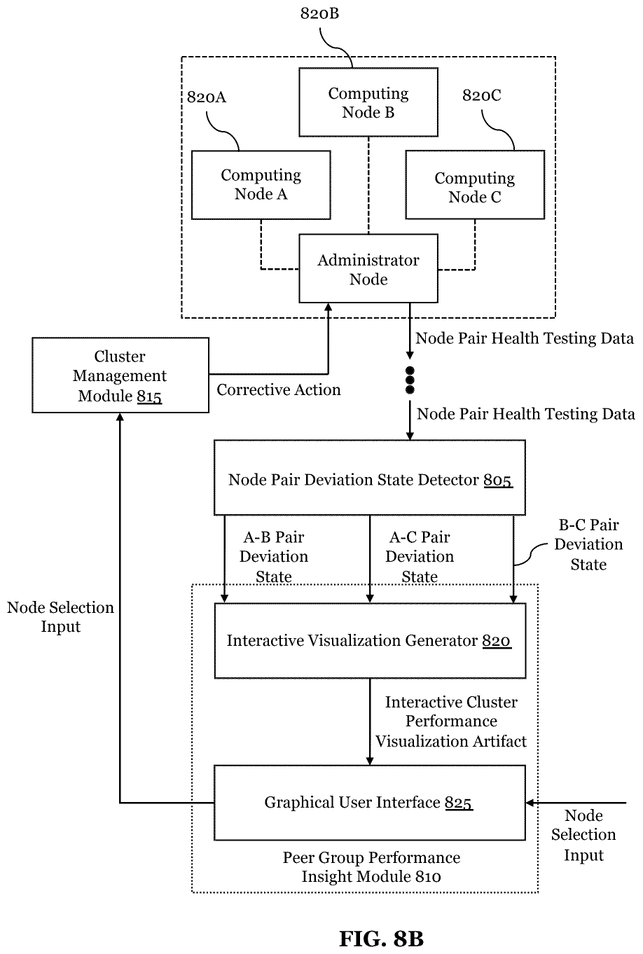

As shown in FIG. 9, process 900 may include step S910, which may include accessing computing node pair health testing data (e.g., node health assessment data) associated with a peer group of computing nodes within a cluster of computing nodes. Step S910 may establish a data acquisition stage that provides structured performance information used in subsequent peer-relative performance evaluation. In some examples, step S210 may be performed by a node pair deviation state detector 805 as depicted with reference to FIGS. 8A and 8B.

Accessing computing node pair health testing data may include implementing a cluster performance insight interface in communication with an administrative computing node (e.g., an administrator node) of the cluster of computing nodes. The cluster performance insight interface may function as a coordination and analytics component configured to collect, organize, and supply computing node pair health testing data for comparative analysis. In some examples, the cluster performance insight interface may instead be in direct communication with health assessment module 120 as described herein or database within which computing node pair health testing data is stored (e.g., in the form of node health assessment data).

Computing node pair health testing data may include performance data generated through execution of coordinated tests (e.g., collective testing) among computing nodes of the cluster of computing nodes. For instance, the performance data may include the results of bi-directional testing or pairwise testing as described herein. In order to access the computing node pair health testing data, the node pair deviation state detector 805 may continuously monitor for new performance information and may incorporate the new performance information into downstream processes (e.g., generating machine-readable node pair deviation states), thereby enabling near-real-time evaluation of comparative performance behavior across the cluster of computing nodes.

In some implementations, computing node pair health testing data may be generated when computing nodes are transitioned into an idle operational state. An “idle operational state” may refer to a state in which a computing node is not assigned to execute a workload associated with an external user job. In some implementations, computing node pair health testing data may be generated as part of micro-jobs scheduled between workload executions. A “micro-job” may refer to a lightweight health testing task scheduled for execution during intervals between primary workload executions. Execution of micro-jobs may enable generation of updated computing node pair health testing data without materially interfering with workload execution. The cluster performance insight interface may detect transition of computing nodes into an idle operational state or initiation of micro-jobs and may access corresponding computing node pair health testing data in near-real-time.

Step S910 may further include identifying a peer group of computing nodes within the cluster of computing nodes. A “peer group” may refer to a subset of computing nodes selected for comparative performance evaluation based on one or more shared attributes. Shared attributes may include common hardware configuration, identical graphics processing unit model, identical central processing unit model, shared network interconnect type, shared rack placement, shared data hall placement, or another structural or operational characteristic. Selection of a peer group may enable performance comparisons among computing nodes exhibiting comparable hardware and network characteristics, thereby supporting detection of peer-relative performance deviations independent of heterogeneous configuration effects.

In some implementations, identification of the peer group may be based on homogeneous grouping of computing nodes that share a defined processing component type or network interconnect component type. In other implementations, identification of the peer group may be based on a logical grouping defined by cluster management policies, resource partition definitions, or workload placement domains. The cluster performance insight interface may query cluster configuration metadata to determine membership of computing nodes within the peer group.

### 3.2 Automatically Generating Machine-Readable Node Pair Deviation States for Pairs of Computing Nodes

As shown in FIG. 9, process 900 may include step S920, which may include automatically generating, for each of two or more pairs of computing nodes of the peer group, a machine-readable node pair deviation state. Step S920 may function as an analytical transformation layer that converts computing node pair health testing data into structured peer-relative performance characterizations suitable for automated operational control and/or visualization.

In some examples, step S920 may be performed by a node pair deviation state detector 805 as depicted with reference to FIGS. 8A and 8B. For instance, node pair deviation state detector 805 may receive node pair health testing data associated with bidirectional tests within a peer group including computing node 820A (i.e., Node A), computing node 820B (i.e., Node B), and computing node 820C (i.e., Node C). For instance, a first portion of the bidirectional tests may occur between computing node 820A and computing node 820B (i.e., Node Pair A-B); a second portion of the bidirectional tests may occur between computing node 820A and computing node 820C (i.e., Node Pair A-C); and a third portion of the bidirectional tests may occur between computing node 820B and computing node 820C (i.e., Node Pair A-C). Node pair deviation state detector 805 may detect node pair deviation states for each of these pairs (e.g., a first node pair deviation state for Node Pair A-B, a second node pair deviation state for Node Pair A-C, and a third node pair deviation state for Node Pair B-C).

A “machine-readable node pair deviation state” may refer to a structured data representation that encodes a peer-relative performance classification associated with a respective pair of computing nodes. The machine-readable node pair deviation state may be formatted as a data object, record, signal, or structured payload. The machine-readable node pair deviation state may encode whether performance behavior associated with the respective pair of computing nodes is consistent with collective performance characteristics of the peer group (e.g., the pair exhibits peer-relative conformance) or whether the respective pair of computing nodes exhibits peer-relative underperformance relative to other pairs within the peer group. In some implementations, the machine-readable node pair deviation state may further encode additional granularity reflecting degree, persistence, or stability of observed peer-relative deviation. The machine-readable node pair deviation state may serve as a standardized representation of comparative performance behavior across the peer group.

In some implementations, automatically generating the machine-readable node pair deviation state for a respective pair of computing nodes may be preceded by comparative derivation and distribution modeling stages. Comparative derivation may include deriving bidirectional performance information characterizing interaction-based performance behavior between computing nodes of the peer group. Distribution modeling may include computing a peer-relative performance distribution representing collective comparative behavior across multiple pairs of computing nodes. Such derivation and modeling stages may provide contextual reference points against which performance behavior of a given pair may be evaluated.

Automatically generating the machine-readable node pair deviation state may include computing a quantified degree of peer-relative performance deviation for the respective pair of computing nodes based on the derived bidirectional performance information and the peer-relative performance distribution. The quantified degree of peer-relative performance deviation may reflect magnitude and direction of divergence of comparative performance behavior relative to representative peer group behavior. The quantified degree of peer-relative performance deviation may then be evaluated against one or more performance deviation thresholds to determine whether the respective pair exhibits peer-relative conformance or peer-relative underperformance. Based on such evaluation, a corresponding classification may be encoded within the machine-readable node pair deviation state.

### 3.2.1 Deriving, for Each Node Pair, Bidirectional Performance Information

In some examples, Step S920 may include deriving bidirectional performance information for each evaluated pair of computing nodes within the peer group. Deriving bidirectional performance information may transform raw computing node health testing data into structured comparative metrics that characterize how two computing nodes perform relative to each other during coordinated interaction. Rather than evaluating each computing node in isolation, deriving bidirectional performance information may focus on how performance of a first computing node compares to performance of a second computing node under substantially similar workload and network conditions.

Computing node health testing data accessed in step S910 may include multiple instances of pairwise testing conducted between members of the peer group. Each instance of pairwise testing may include coordinated execution of computational workloads, coordinated data transmission between computing nodes, or a combination of computational and network interaction. During each instance, performance metrics may be recorded for both computing nodes participating in the interaction. Deriving bidirectional performance information may include extracting comparative performance characteristics from such pairwise test results.

Comparative performance characteristics may include relative differences between data processing rates observed at a first computing node and data processing rates observed at a second computing node during coordinated workload execution. Comparative performance characteristics may additionally include directional differences in data transmission rates between a first direction of communication and a reverse direction of communication across a network interconnect linking the computing nodes. In some implementations, comparative performance characteristics may further include latency offsets, throughput deltas, or temperature-correlated performance variation observed during coordinated stress testing. Such comparative performance characteristics may reveal asymmetries or degradations that are not apparent from absolute performance measurements evaluated independently.

Deriving bidirectional performance information may include aggregating results from multiple pairwise interactions between a given pair of computing nodes across multiple assessment intervals. Aggregation may reduce the influence of transient noise, workload jitter, or environmental fluctuations that may affect a single assessment interval. For example, aggregation may include averaging comparative processing rate differences across multiple tests, computing percentile-based summaries of transmission asymmetry, or applying weighted combinations of historical and recent measurements. Aggregated representations may provide a more stable and reliable characterization of relative performance between two computing nodes.

Deriving bidirectional performance information may further include maintaining temporal relevance of performance characterization. Computing node health testing data may be generated periodically, during idle operational states, or through execution of micro-jobs interleaved between workload executions. Performance characteristics observed at an earlier time may not accurately reflect present conditions due to hardware aging, thermal changes, workload evolution, or topology adjustments. Accordingly, deriving bidirectional performance information may include applying a temporal freshness criterion that excludes stale test results and emphasizes more recent observations. Such temporal filtering may enable peer-relative performance analysis to reflect current cluster conditions rather than historical states that are no longer representative.

In some implementations, additional computing node health testing data may become available during operation of the cluster. Deriving bidirectional performance information may therefore include dynamically incorporating newly generated pairwise test results into existing comparative characterizations. Updating bidirectional performance information as additional test data becomes available may support near-real-time adaptation of subsequent peer-relative performance evaluation and cluster management decisions.

Changes in membership of the peer group may also affect bidirectional performance characterization. Removal of a computing node from the peer group due to reconfiguration, maintenance, or reassignment may invalidate comparative metrics associated with pairs that include the removed computing node. Deriving bidirectional performance information may therefore include detecting peer group membership changes and excluding comparative metrics associated with removed computing nodes from further analysis. Such adaptive recalibration may preserve integrity of peer-relative evaluation as cluster composition evolves.

Deriving bidirectional performance information may therefore generate, for each evaluated pair of computing nodes, a structured comparative representation of relative computational and network performance behavior. Such structured comparative representation may serve as a foundation for subsequent computation of a peer-relative performance distribution and for determination of whether a given pair exhibits peer-relative conformance or peer-relative underperformance within the peer group.

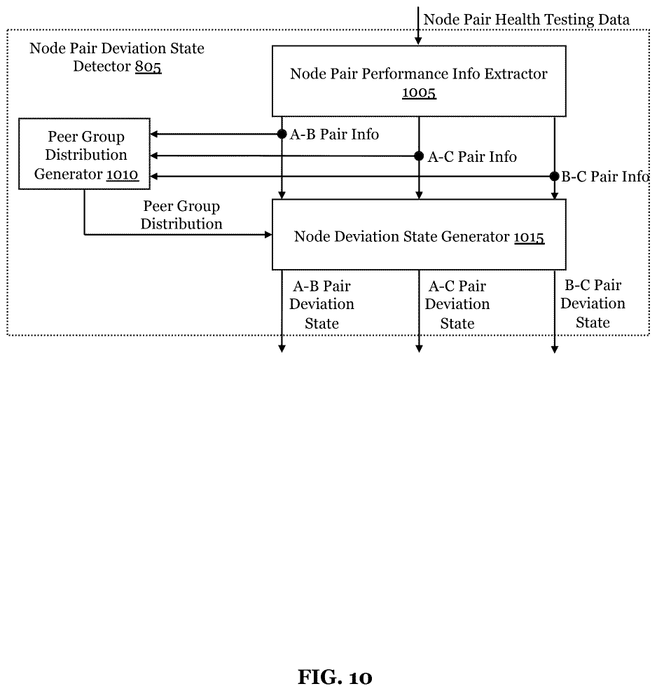

In a non-limiting example of deriving bidirectional performance information, as described with reference to FIG. 10, a node pair performance info extractor 1005 of node pair deviation state detector 805 may derive bidirectional performance information for Node Pair A-B, Node Pair A-C, and Node Pair-B-C and may provide the bidirectional performance information to node deviation state generator 1015 and peer group distribution generator 1010.

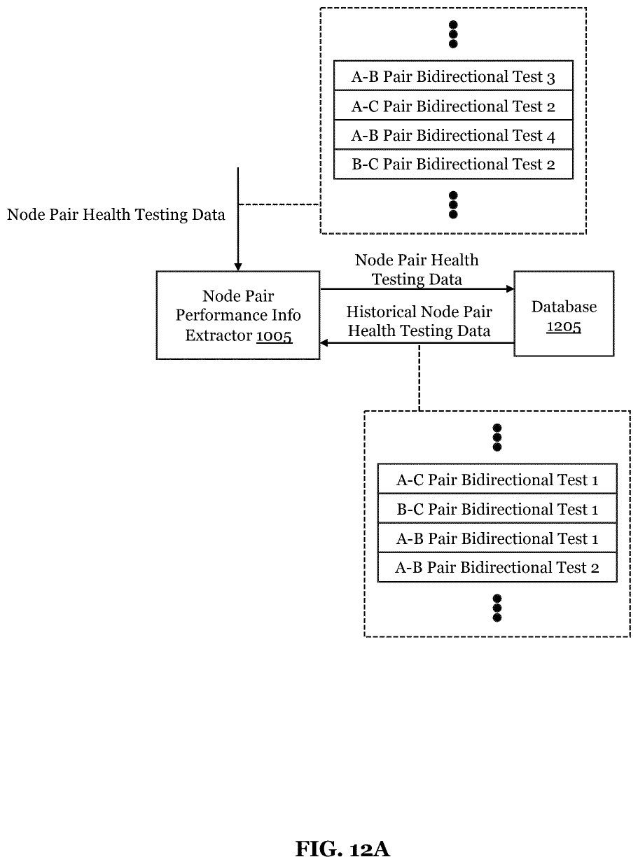

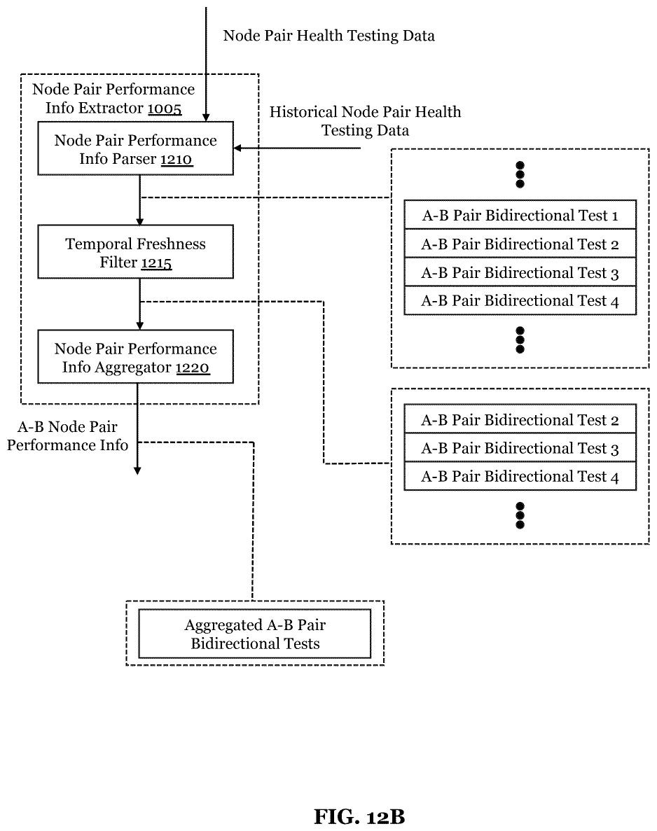

In an additional non-limiting example of deriving bidirectional performance information for Node Pair A-B, as described with reference to FIGS. 12A and 12B, node pair performance info extractor 1005 may receive node pair health testing data including multiple results of bidirectional tests. For instance, the node pair health testing data may include two bidirectional test results for Node Pair A-B; one bidirectional test result for Node Pair A-C and one bidirectional test result for Node Pair B-C. Each of the two bidirectional test results for Node Pair A-B may be captured over separate assessment intervals (e.g., may have an associated unique timestamp relative to each other).

Additionally, node pair performance info extractor 1005 may receive historical node pair health testing data (e.g., from a database 1205). The historical node pair health testing data may include previously received bidirectional test results. For instance, the historical node pair health testing data may include two bidirectional test results for Node Pair A-B; one bidirectional test result for Node Pair A-C; and one bidirectional test result for Node Pair B-C. Each of the two previously received bidirectional test results for Node Pair A-B may be captured over separate assessment intervals (e.g., may have an associated unique timestamp relative to each other and also to the two most recently received bidirectional results). It should be noted that node pair performance info extractor 1005 may store the most recently received node pair health testing data in database 1205, thus enabling the corresponding bidirectional test results to be used as historical node pair health testing data for future bidirectional performance info extraction.

The node pair health testing data and the historical node pair health testing data may be received by node pair performance info parser 1210 of node pair performance info extractor 1005. The node pair performance info parser 1210 may parse out the bidirectional test results for Node Pair B-C and the bidirectional test results for Node Pair A-C, leaving only the four bidirectional test results for Node Pair A-B (e.g., two from the node pair health testing data and two from the historical node pair health testing data). The node pair performance info parser 1210 may provide the filtered set to temporal freshness filter 1215.

Temporal freshness filter 1215 may compare the bidirectional test results for Node Pair A-B to a temporal freshness threshold to ensure that only bidirectional test results with a threshold degree of recency are used for computing machine-readable deviation states. For instance, temporal freshness filter 1215 may determine that one of the two bidirectional test results in the historical node pair health testing data have a timestamp that fails to satisfy the temporal freshness threshold (e.g., the temporal freshness threshold is 2 hours and the bidirectional test result has a timestamp that is exceeds 2 hours from a time at which the temporal freshness filter 1215 is making determinations). Accordingly, the temporal freshness filter 1215 may filter these bidirectional test results out and may provide the remaining bidirectional test results for Node Pair A-B to node pair performance info aggregator 1220. Node pair performance info aggregator 1220 may receive the remaining bidirectional test results and may aggregate them in order to generate A-B Node Pair performance information. The aggregated bidirectional test results may then be forwarded to peer group distribution generator 1010 and/or node deviation state generator 1015. It should be noted that there may be cases in which aggregation is skipped and the raw bidirectional test results may be provided to peer group distribution generator 1010 and node deviation state generator 1015. In such examples, node deviation state generator 1015 may perform the aggregation or may determine a separate node deviation state for each bidirectional test result.

### 3.2.2 Computing, for the Peer Group, a Peer-relative Performance Distribution

Step S920 may further include computing a peer-relative performance distribution across the peer group of computing nodes based on the bidirectional performance information derived for evaluated pairs of computing nodes. Computing the peer-relative performance distribution may include generating a collective statistical representation that characterizes how comparative performance behavior is distributed across the peer group. The peer-relative performance distribution may provide contextual grounding for evaluating whether comparative behavior observed for a particular pair of computing nodes is typical or atypical relative to the broader peer group.

Computing the peer-relative performance distribution may include aggregating bidirectional performance information derived for multiple pairs of computing nodes within the peer group. Such aggregation may generate one or more central tendency metrics reflecting a representative comparative performance level across the peer group. Central tendency metrics may include a mean value, a median value, a percentile-based value, or another representative statistical measure. A central tendency metric may represent a baseline comparative performance level against which individual pairwise comparative representations may be evaluated.

Computing the peer-relative performance distribution may further include generating one or more dispersion metrics reflecting variability of comparative performance behavior across the peer group. Dispersion metrics may include variance, standard deviation, interquartile range, or another measure characterizing spread or variability within the aggregated bidirectional performance information. A dispersion metric may quantify how tightly clustered or broadly distributed comparative performance behavior is across the peer group.

In a non-limiting example, as described with reference to FIG. 10, peer group distribution generator 1010 may receive bidirectional performance information associated Node Pair A-B, Node Pair A-C, and Node Pair B-C and may generate a peer-relative performance distribution from the bidirectional performance information. It should also be noted that there may be examples in which the peer group distribution generator instead receives the node pair health testing data directly and may parse out which bidirectional test results correspond to node pairs in the peer group.

### 3.2.3 Generating Machine-Readable Deviation States Using the Peer-Relative Performance Distribution and the Bidirectional Performance Information

Step S920 may further include generating, for each evaluated pair of computing nodes within the peer group, a corresponding machine-readable node pair deviation state. Generating the machine-readable node pair deviation state may include evaluating comparative performance behavior associated with the respective pair of computing nodes relative to collective behavior of the peer group and producing a structured classification reflecting the result of such evaluation.

Generation of the machine-readable node pair deviation state may include multiple analytical stages. A first analytical stage may include computing a quantified degree of peer-relative performance deviation for the respective pair of computing nodes based on bidirectional performance information associated with the respective pair and the peer-relative performance distribution computed for the peer group. A second analytical stage may include determining whether the quantified degree of peer-relative performance deviation satisfies one or more performance deviation thresholds. A third analytical stage may include encoding, within the machine-readable node pair deviation state, a classification corresponding to the outcome of threshold evaluation.

The quantified degree of peer-relative performance deviation may represent a context-aware deviation measure reflecting magnitude and direction of divergence of comparative performance behavior relative to representative peer group behavior. The performance deviation threshold may represent a configurable boundary separating peer-relative conformance from peer-relative underperformance. Encoding of classification information within the machine-readable node pair deviation state may enable standardized representation of peer-relative performance behavior in a format consumable by cluster management interfaces and/or visualization mechanisms as described herein.

Structuring generation of the machine-readable node pair deviation state into distinct analytical stages may improve configurability and adaptability of peer-relative performance evaluation. Separation of deviation quantification, threshold evaluation, and state encoding may enable adjustment of deviation sensitivity without altering distribution computation logic and may enable multiple classification schemes to operate over a shared quantified deviation measure.

In a non-limiting example, as described with reference to FIG. 10, node deviation state generator 1015 of node pair deviation state detector 805 may receive bidirectional performance information for Node Pair A-B, Node Pair A-C, and Node Pair B-C from node pair performance info extractor 1005. Additionally, node pair deviation state generator 1015 may receive a peer group distribution from peer group distribution generator 1010. Using the bidirectional performance information and the peer group distribution, node deviation state generator 1015 may determine a first deviation state for Node Pair A-B; a second deviation state for Node Pair A-C; and a third deviation state for Node Pair B-C.

### 3.2.3.1 Computing a Quantified Degree of Peer-Relative Performance Deviation

A first analytical stage of generating the machine-readable node pair deviation state may include computing a quantified degree of peer-relative performance deviation for a respective pair of computing nodes within the peer group. Computing the quantified degree of peer-relative performance deviation may include determining a directional performance offset between derived bidirectional performance information associated with the respective pair and a central tendency metric of the peer-relative performance distribution. The directional performance offset may represent a signed magnitude reflecting whether comparative performance behavior associated with the respective pair exceeds or falls below representative peer group behavior. A negative directional performance offset may indicate that comparative performance behavior associated with the respective pair is lower than representative peer group behavior, while a positive directional performance offset may indicate comparatively stronger performance behavior.

Computing the quantified degree of peer-relative performance deviation may further include scaling the directional performance offset using one or more dispersion metrics associated with the peer-relative performance distribution. Scaling may normalize the directional performance offset relative to variability of comparative behavior across the peer group. For example, in a peer group exhibiting tightly clustered comparative performance behavior, a relatively small directional performance offset may correspond to a meaningful deviation. In a peer group exhibiting broader variability, a similar directional performance offset may represent comparatively minor divergence. Scaling relative to dispersion may therefore produce a normalized deviation measure that reflects contextual significance of comparative performance behavior.

In some implementations, computing the quantified degree of peer-relative performance deviation may include evaluating deviation across multiple comparative performance parameters derived from bidirectional performance information. Comparative performance parameters may include comparative data processing performance values, comparative data transmission performance values, or other interaction-based metrics. Computing the quantified degree of peer-relative performance deviation may include combining deviations across multiple parameters using weighted aggregation, vector-based distance measures, or other composite scoring techniques. Composite evaluation may enable multi-dimensional performance divergence to be reflected in a single quantified deviation measure.

The quantified degree of peer-relative performance deviation may therefore represent a normalized, direction-aware, and context-sensitive measure of comparative performance divergence for a respective pair of computing nodes within the peer group. The quantified degree of peer-relative performance deviation may serve as the primary analytical input for subsequent evaluation against performance deviation thresholds and for encoding of peer-relative conformance or peer-relative underperformance classifications within the machine-readable node pair deviation state.

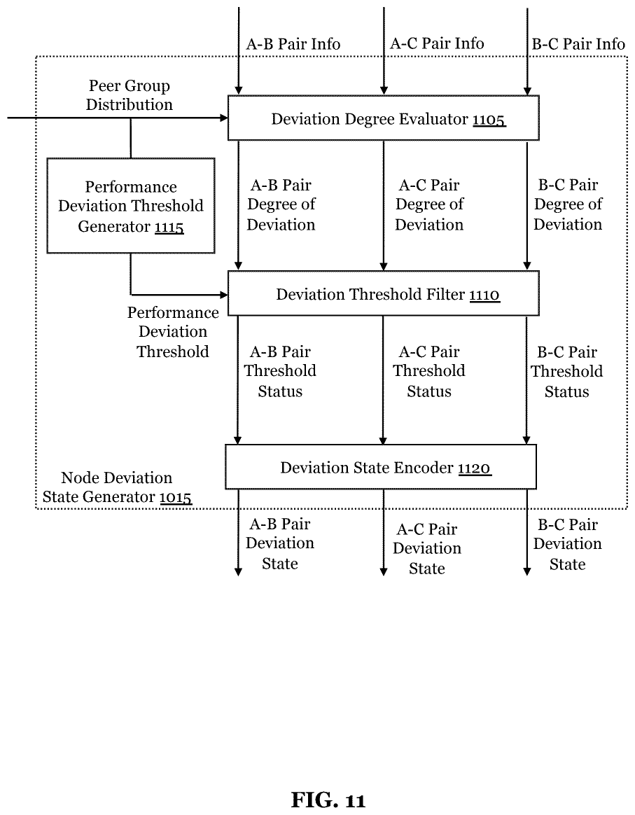

In a non-limiting example, as described with reference to FIG. 11, deviation degree evaluator 1105 of node deviation state generator 1015 may receive bidirectional performance information for Node Pair A-B, Node Pair A-C, and Node Pair B-C as well as a corresponding peer group distribution. Using the peer group distribution and the bidirectional performance information for Node Pair A-B, node deviation state generator 1015 may determine a degree of deviation for Node Pair A-B. Similarly, using the peer group distribution and the bidirectional performance information for Node Pair A-C, deviation degree evaluator 1105 may determine a degree of deviation for Node Pair A-C. Additionally, using the peer group distribution and the bidirectional performance information for Node Pair B-C, deviation degree evaluator 1105 may determine a degree of deviation for Node Pair B-C. The deviation degree evaluator 1105 may provide the degrees of deviation to deviation threshold filter 1110.

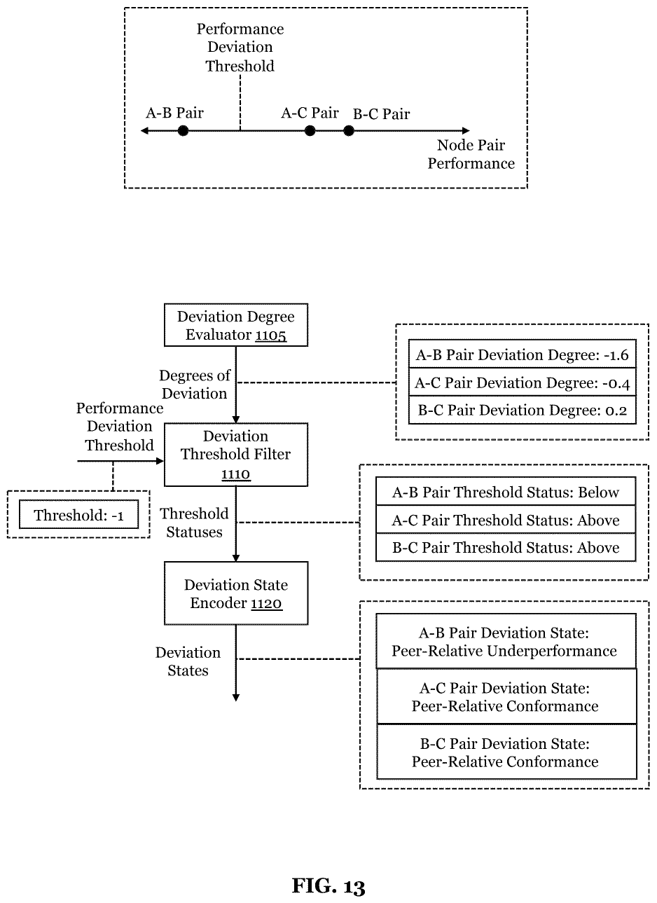

In another non-limiting example, as described with reference to FIG. 13, deviation degree evaluator 1105 may determine that the A-B Node Pair has a deviation degree of −1.6 (e.g., is 1.6 standard deviations away from a mean of the peer group distribution in a negative direction), that the A-C Node Pair has a deviation degree of −0.4; and that the B-C Node Pair has a deviation degree of 0.2 (e.g., is 0.2 standard deviations away from a mean of the peer group distribution in a positive direction).

### 3.2.3.2 Determining Satisfaction of a Performance Deviation Threshold

A second analytical stage of generating the machine-readable node pair deviation state may include determining whether the quantified degree of peer-relative performance deviation associated with a respective pair of computing nodes satisfies one or more performance deviation thresholds. Determining satisfaction of a performance deviation threshold may include evaluating whether magnitude and direction of the quantified degree of peer-relative performance deviation indicate divergence from representative peer group behavior beyond a defined deviation boundary.

A performance deviation threshold may represent a configurable deviation magnitude selected to distinguish typical peer-relative variation from atypical comparative divergence. The performance deviation threshold may be defined as a fixed numerical value, may be derived as a function of dispersion characteristics of the peer-relative performance distribution, or may be adjusted dynamically based on cluster management policies. In some implementations, different performance deviation thresholds may be defined for different categories of workloads, hardware configurations, or peer groups.

Determining whether the quantified degree of peer-relative performance deviation satisfies the performance deviation threshold may include evaluating directional characteristics of the deviation. Comparative performance divergence that falls below representative peer group behavior may be treated differently from comparative performance divergence that exceeds representative peer group behavior. In some implementations, only deviation in a direction corresponding to degraded comparative behavior may be considered for threshold satisfaction, while positive divergence may be ignored or evaluated under separate criteria.

In some implementations, determination of threshold satisfaction may involve evaluation against multiple deviation thresholds. A first performance deviation threshold may represent a boundary for significant peer-relative underperformance. A second performance deviation threshold may represent a lower boundary associated with emerging or intermediate divergence. Multi-threshold evaluation may enable graded sensitivity in deviation detection, allowing differentiation between minor variation, emerging divergence, and sustained underperformance.

Determining satisfaction of a performance deviation threshold may further include evaluating persistence of deviation across multiple assessment intervals. A single assessment interval may reflect transient workload imbalance, temporary thermal fluctuation, or measurement variance. Evaluation of deviation across multiple intervals may include determining whether the quantified degree of peer-relative performance deviation satisfies the performance deviation threshold for at least a threshold quantity of assessment intervals. Persistent satisfaction of the performance deviation threshold across multiple assessment intervals may indicate a sustained comparative divergence pattern rather than a transient anomaly.

In some implementations, computing the performance deviation threshold may include deriving the performance deviation threshold from statistical characteristics of the peer-relative performance distribution. For example, the performance deviation threshold may be computed as a function of a dispersion metric associated with the peer-relative performance distribution. The performance deviation threshold may correspond to a multiple of a standard deviation value, a percentile boundary, an interquartile range boundary, or another statistically derived cutoff reflecting expected variability within the peer group. Deriving the performance deviation threshold from dispersion characteristics may enable adaptive sensitivity in deviation detection, such that tighter peer group clustering results in a lower deviation boundary and broader peer group variability results in a higher deviation boundary.

In some implementations, computing the performance deviation threshold may include evaluating historical deviation behavior across multiple assessment intervals. Historical deviation behavior may include distribution of quantified degrees of peer-relative performance deviation observed over time. The performance deviation threshold may be selected based on observed stability patterns, drift characteristics, or deviation persistence metrics associated with the peer group. Such temporal derivation may enable the performance deviation threshold to reflect not only instantaneous dispersion characteristics but also long-term stability of comparative performance behavior within the cluster of computing nodes.

In some implementations, determination of threshold satisfaction may be performed independently of absolute performance acceptability criteria. A respective pair of computing nodes may satisfy throughput constraints, service-level agreement constraints, or other standalone performance thresholds while still exhibiting peer-relative deviation exceeding the performance deviation threshold. Determining threshold satisfaction based on peer-relative deviation rather than absolute compliance may enable detection of latent performance degradation or topology-induced asymmetry that may not trigger conventional health monitoring mechanisms.

Determining whether the quantified degree of peer-relative performance deviation satisfies one or more performance deviation thresholds may therefore provide a context-sensitive classification decision point that distinguishes peer-relative conformance from peer-relative underperformance.

In a non-limiting example, as described with reference to FIG. 11, performance deviation threshold generator 1115 may receive a peer group distribution and may determine, from the peer group distribution, a performance deviation threshold. The performance derivation threshold generator 1115 may provide the performance deviation threshold to deviation threshold filter 1110. The derivation threshold filter 1110 may compare the degree of deviation for Node Pair A-B to the performance deviation threshold and may determine a threshold status for Node Pair A-B. Similarly, the derivation threshold filter 1110 may compare the degree of deviation for Node Pair A-C to the performance deviation threshold and may determine a threshold status for Node Pair A-C. Additionally, the deviation threshold filter 1110 may compare the degree of deviation for Node Pair B-C to the performance deviation threshold and may determine a threshold status for Node Pair B-C. The deviation threshold filter 1110 may output the threshold statuses to deviation state encoder 1120.

In an additional non-limiting example, as described with reference to FIG. 13, the performance deviation threshold received by deviation threshold filter 1110 may have a value of −1 (e.g., −1 standard deviations below a mean of the peer group distribution). Accordingly, the deviation threshold filter 1110 may determine that Node Pair A-B, with a deviation degree of −1.6 may have a deviation degree below the deviation threshold and may set the corresponding threshold status as below the deviation threshold. Similarly, the deviation threshold filter 1110 may determine that Node Pairs A-C and B-C, with deviation degrees of −0.4 and 0.2 may have deviation degrees above the deviation threshold and may set the corresponding threshold status as above the deviation threshold.

### 3.2.3.3 Encoding Peer-relative Conformance or Underperformance Within the Machine-readable Node Pair Deviation State

A third analytical stage of generating the machine-readable node pair deviation state may include encoding, within the machine-readable node pair deviation state, a classification corresponding to results of performance deviation threshold evaluation described herein. Encoding may include constructing a structured data representation associated with the respective pair of computing nodes and embedding within the structured data representation one or more indicators reflecting peer-relative performance classification.

When the quantified degree of peer-relative performance deviation associated with the respective pair of computing nodes satisfies a performance deviation threshold in a direction corresponding to degraded comparative behavior, encoding may include designating the respective pair of computing nodes as exhibiting peer-relative underperformance. When the quantified degree of peer-relative performance deviation fails to satisfy the performance deviation threshold, encoding may include designating the respective pair of computing nodes as exhibiting peer-relative conformance relative to the peer group.

In implementations supporting multi-threshold evaluation, encoding may further include representing intermediate classifications reflecting emerging or moderate comparative divergence. For example, when the quantified degree of peer-relative performance deviation satisfies a lower deviation threshold but does not satisfy a higher deviation threshold, encoding may include designating the respective pair of computing nodes as exhibiting an intermediate deviation state. Multi-level encoding may enable differentiated operational responses based on severity or progression of comparative divergence.

Encoding within the machine-readable node pair deviation state may include representing deviation magnitude, deviation direction, deviation persistence, or stability characteristics in addition to categorical classification. For example, encoding may include storing a normalized deviation measure, an indicator of the number of assessment intervals for which the performance deviation threshold was satisfied, or a confidence score associated with classification. Inclusion of such contextual metadata may enable downstream systems to perform more granular operational decision-making.

In some implementations, encoding may explicitly represent latent degradation conditions. Latent degradation conditions may arise when comparative performance behavior associated with the respective pair of computing nodes satisfies peer-relative deviation criteria while continuing to satisfy one or more absolute performance acceptability criteria. Encoding such conditions within the machine-readable node pair deviation state may enable detection and response to emerging divergence patterns prior to violation of absolute health thresholds.

The machine-readable node pair deviation state may be structured as a data object, structured record, message payload, or other encoded data signal consumable by cluster management interfaces or visualization mechanisms. The machine-readable node pair deviation state may include identifiers associated with the respective pair of computing nodes, classification indicators, deviation magnitude values, temporal stability indicators, and additional metadata relevant to operational control.

Encoding peer-relative conformance or peer-relative underperformance within the machine-readable node pair deviation state may therefore provide a standardized and interoperable representation of comparative performance behavior across the peer group. Such structured representation may enable automated workload placement decisions, performance-sensitive resource allocation, logical grouping of computing nodes, or other cluster management actions based on peer-relative performance intelligence rather than solely on absolute health indicators.

In a non-limiting example, as described with reference to FIG. 11, deviation state encoder 1120 of node deviation state generator 1015 may receive threshold statuses for Node Pair A-B, Node Pair A-C, and Node Pair B-C and may encode a machine-readable node pair deviation state based on the threshold status values for each node pair. Deviation state encoder 1120 may then output the respective machine-readable node pair deviation states for each of Node Pair A-B, Node Pair A-C, and Node Pair B-C.

In another non-limiting example, as described with reference to FIG. 13, deviation state encoder 1120 may receive a threshold status for Node Pair A-B indicating that Node Pair A-B is below a performance deviation threshold. Accordingly, deviation state encoder 1120 may encode a deviation state for Node Pair A-B indicating peer-relative underperformance for Node Pair A-B. Additionally, deviation state encoder 1120 may receive threshold statuses for Node Pairs A-C and B-C indicating that these Node Pairs are above the performance deviation threshold. Accordingly, deviation state encoder 1120 may encode respective deviation states for Node Pairs A-C and B-C indicating peer-relative conformance for these Node Pairs.

### 3.3 Rendering an Interactive Cluster Performance Visualization Artifact Based on the Machine-Readable Node Pair Deviation States

In some implementations, process 900 may further include step S930, which may include automatically rendering an interactive cluster performance visualization artifact including a plurality of node pair representations corresponding to the peer group of computing nodes. Each node pair representation may be encoded with visual attributes indicating a machine-readable node pair deviation state associated with a respective pair of computing nodes. Step S930 may function to present peer-relative performance intelligence generated in step S920 in a structured and interpretable graphical format.

Rendering the interactive cluster performance visualization artifact may include generating a graphical representation that spatially organizes node pair representations according to identifiers associated with computing nodes of the peer group. The interactive cluster performance visualization artifact may be displayed via a graphical user interface delivered through an administrative console, browser-based interface, or other visualization environment in communication with the cluster performance insight interface.

Each node pair representation may correspond to a specific pair of computing nodes evaluated in step S920. Visual attributes associated with each node pair representation may reflect peer-relative performance classification encoded within a corresponding machine-readable node pair deviation state. Visual attributes may include color value, color intensity, shading, graphical markers, or other visually distinguishable characteristics. Such visual encoding may enable rapid differentiation between peer-relative conformance and peer-relative underperformance across the peer group.

The interactive cluster performance visualization artifact may provide a spatially organized overview of comparative performance relationships among computing nodes within the peer group. By arranging node pair representations in a structured layout, the interactive cluster performance visualization artifact may enable identification of correlated deviation patterns associated with shared hardware configurations, shared network interconnect pathways, shared rack placement, or shared data hall placement.

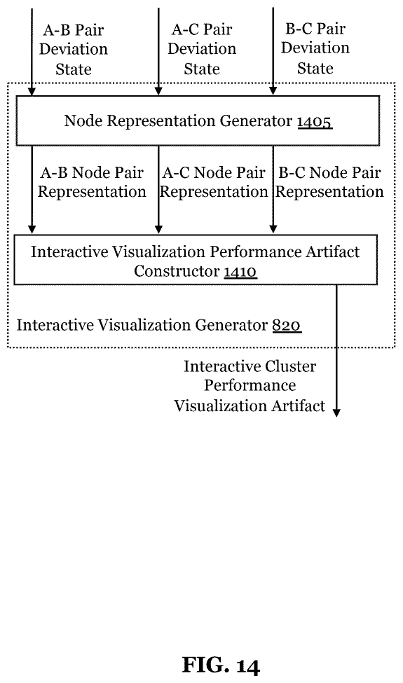

In a non-limiting example, as described with reference to FIG. 8B, interactive visualization generator 820 may receive deviation states for Node Pairs A-B, A-C, and B-C from node pair deviation state detector 805 and may construct an interactive cluster performance visualization artifact with node pair representations that are encoded based on the deviation states. For instance, as depicted in FIG. 14, node pair representation generator 1405 of interactive visualization generator 820 may receive Node Pair A-B and may generate a corresponding node pair representation encoded with visual attributes indicating the deviation state for Node Pair A-B. Likewise, node pair representation generator 1405 may receive deviation states corresponding to Node Pairs A-C and B-C and may generate respective node pair representations encoded with visual attributes indicating the deviation states for Node Pair A-C and Node Pair B-C, respectively. Node pair representation generator 1405 may provide the node pair representations to interactive visualization performance artifact constructor 1410, which may integrate node pair representations into the interactive visualization performance artifact when performing construction. The interactive visualization performance artifact constructor 1410 may then render the interactive cluster performance visualization artifact at graphical user interface 825.

### 3.3.1 Visual Structure of the Interactive Cluster Performance Visualization Artifact

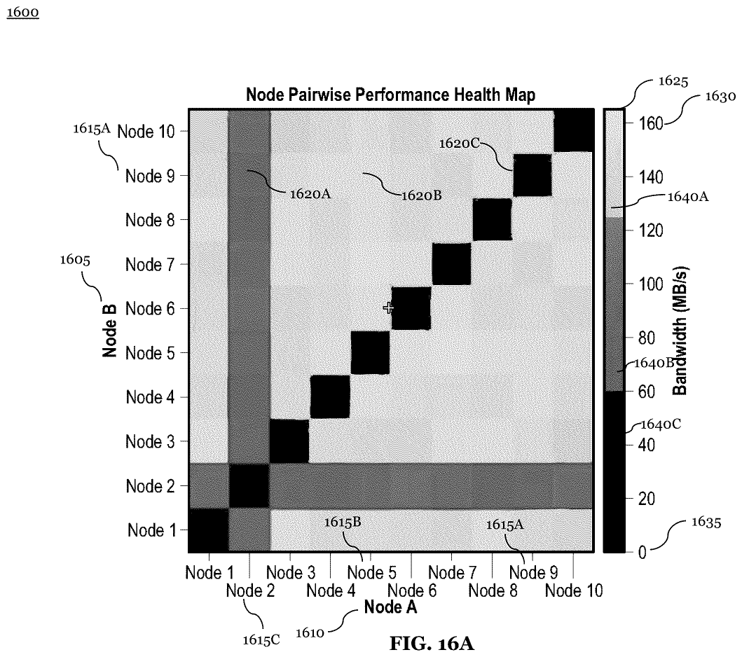

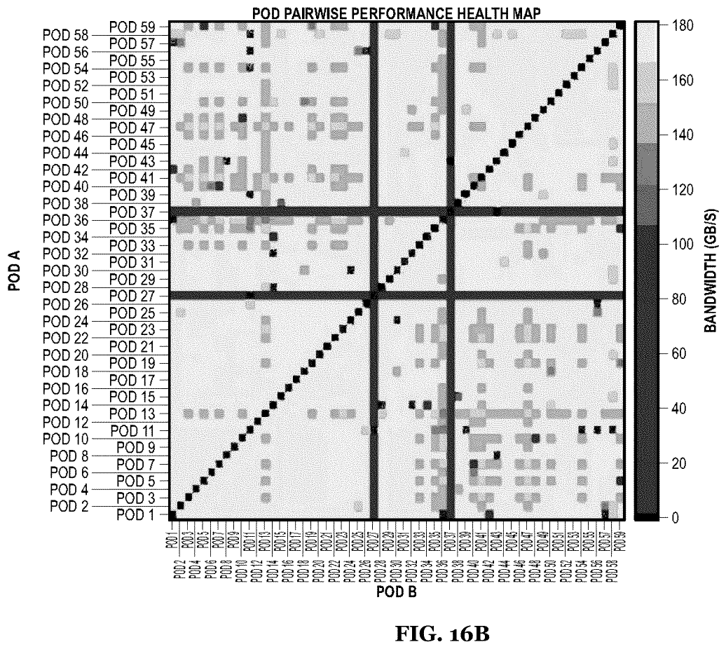

In some implementations, the interactive cluster performance visualization artifact may be rendered as a heat map corresponding to pairwise relationships among computing nodes of the peer group. The heat map may include a two-dimensional grid structure in which a first axis corresponds to identifiers associated with computing nodes of the peer group and a second axis corresponds to identifiers associated with computing nodes of the peer group. Identifiers may include node identifiers, hostnames, rack positions, logical cluster indices, or other unique node designations. For instance, as depicted with reference to FIG. 16A, a heatmap 1600 may include a first axis 1605 corresponding to identifiers associated with computing nodes and a second axis 1610 also corresponding to identifiers associated with computing nodes.

Within the two-dimensional grid structure, an intersection between a first node identifier on the first axis and a second node identifier on the second axis may correspond to a node pair representation associated with the respective pair of computing nodes. The node pair representation may be rendered as a square, rectangle, or other graphical element occupying a grid cell at the intersection. Each such graphical element may correspond to a machine-readable node pair deviation state for the respective pair of computing nodes. In a non-limiting example, as illustrated with reference to FIG. 16A, grid cell 1620A may be associated with a first node pair representation corresponding to nodes 1615A and 1615C. Likewise, grid cell 1620B may be associated with a second node pair representation corresponding to nodes 1615A and 1615B.

In some implementations, grid cells corresponding to intersections where the first node identifier and the second node identifier refer to the same computing node may be rendered using a default visual encoding. For example, a neutral color, muted shading, or predefined placeholder value may be used for diagonal grid positions where a computing node would otherwise be paired with itself. Rendering such positions using a default visual encoding may visually distinguish meaningful pairwise comparative data from non-comparative diagonal positions. In a non-limiting example, as illustrated with reference to FIG. 16A, grid cell 1620C may correspond to the same node and may thus have a default visual encoding.

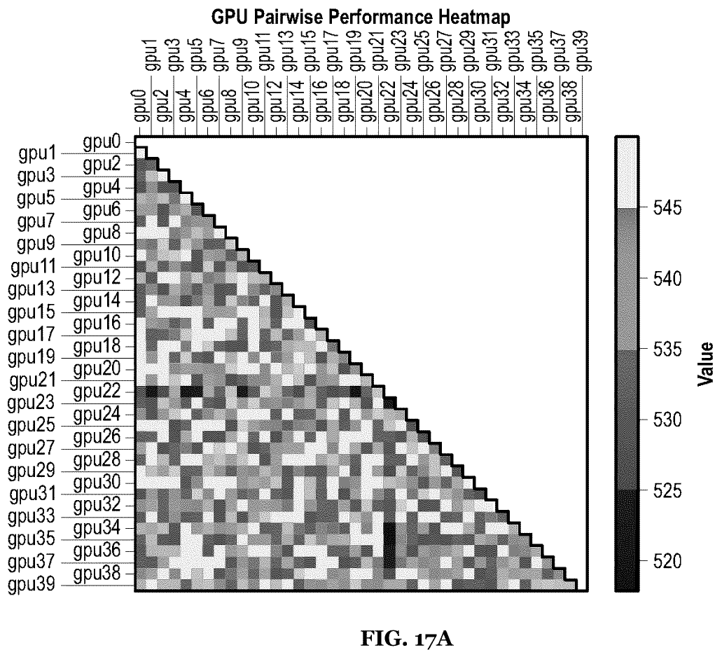

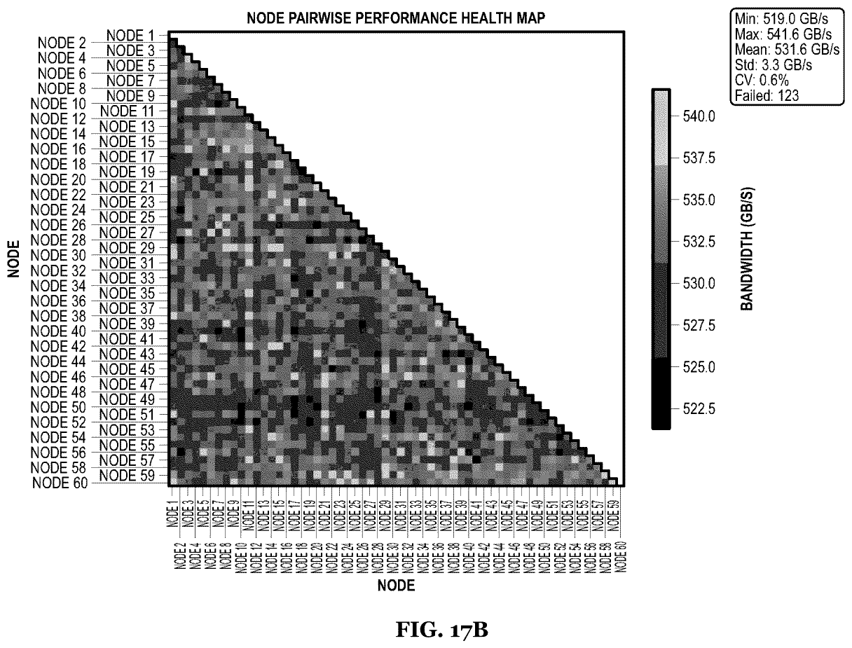

In some implementations, the heat map may be rendered using only a triangular portion of the two-dimensional grid structure. Pairwise comparative evaluation between a first computing node and a second computing node may be logically equivalent to evaluation between the second computing node and the first computing node in contexts where bidirectional performance information is symmetric or aggregated. In such implementations, rendering both upper and lower triangular regions of the grid may be redundant. Accordingly, the interactive cluster performance visualization artifact may display only one triangular portion of the grid, thereby emphasizing unique pairwise relationships and reducing visual redundancy. FIGS. 17A and 17B may depict examples of heatmaps generated using the triangular portion, whereas FIGS. 16A and 16B may depict examples of heatmaps generated using a rectangular or square portion.

Each node pair representation within the heat map may be visually encoded using one or more visual attributes corresponding to the machine-readable node pair deviation state associated with the respective pair of computing nodes. Visual attributes may include color value, color intensity, hue, saturation, brightness, shading pattern, graphical marker size, graphical annotation, or a combination thereof. Mapping of machine-readable node pair deviation states to visual attributes may enable pairs of computing nodes exhibiting peer-relative conformance and pairs of computing nodes exhibiting peer-relative underperformance to be visually distinguishable within the interactive cluster performance visualization artifact.

In some implementations, a color gradient may be used to represent magnitude and direction of peer-relative performance deviation. For example, one region of a color spectrum may correspond to peer-relative conformance, while another region of the color spectrum may correspond to peer-relative underperformance. Intermediate colors may represent emerging or moderate deviation levels. Color intensity or saturation may reflect magnitude of deviation, enabling stronger divergence to be visually emphasized relative to minor variation. Such visual encoding may allow subtle quantitative differences in machine-readable node pair deviation states to become perceptible through color contrast. In a non-limiting example, as described with reference to FIG. 16A, heatmap 1600 may include a color gradient 1625 with regions 1604A, 1604B, and 1604C. Node representations with a color in first region 1604A may represent peer-relative conformance; node representations with a color in second region 1605B may represent a first degree of peer-relative underperformance (e.g., performance that meets absolute criteria but is less performant relative to other node pairs); and node representations with a color in second region 1604C may represent a second degree of peer-relative underperformance (e.g., performance that fails to meet absolute criteria and/or that is less performant relative to node pairs with color in second region 1604B). In the present example, grid cell 1620A may be in the second region 1604B and, accordingly, the node pair including nodes 1615A and 1615C may be exhibiting peer-relative underperformance. Likewise, grid cell 1620B may be in first region 1604A and, accordingly, the node pair including nodes 1615A and 1615B may be exhibiting peer-relative conformance.

Visual encoding within the heat map may contribute to rapid identification of peer-relative underperformance by enabling pattern recognition across the grid structure. Clusters of similarly colored node pair representations may indicate correlated deviation associated with a common computing node, shared rack, shared data hall, shared interconnect pathway, or other structural attribute. For example, a vertical or horizontal band of visually similar deviation indicators may suggest that a single computing node participates in multiple pairs exhibiting peer-relative underperformance (e.g., node 1615C in FIG. 16A). A block of contiguous deviation indicators may suggest a topology-induced performance asymmetry affecting a subset of computing nodes.

Visual encoding may further enable identification of underperformance trends that automated classification mechanisms may not explicitly detect. Automated threshold-based classification as described herein may identify pairs satisfying predefined deviation criteria. However, a human reviewer observing the heat map may detect emerging gradient shifts, spatial clustering, or progressive color transitions across adjacent node pair representations that do not yet satisfy deviation thresholds but may indicate early-stage divergence. Human pattern recognition applied to structured visual representation may therefore complement automated deviation detection by revealing correlated or trending patterns across the peer group.

The interactive cluster performance visualization artifact may therefore provide a spatially organized and visually differentiated representation of machine-readable node pair deviation states that enhances interpretability of peer-relative performance behavior across the cluster of computing nodes. Such visual encoding may support informed decision-making regarding workload placement, logical grouping of computing nodes, preventative maintenance actions, or further diagnostic investigation.

### 3.3.2 Automatic Determination of Visualization Bounds and Scaling Based on Peer-relative Performance Distribution

In some implementations, generating the interactive cluster performance visualization artifact may include automatically determining one or more visualization bounds based on the peer-relative performance distribution. Visualization bounds may define a numerical range used to map comparative performance values or quantified deviation measures to corresponding visual attributes within the heat map or other graphical representation.

Determination of visualization bounds may include identifying lower and upper reference values derived from statistical characteristics of the peer-relative performance distribution. For example, visualization bounds may be based on a minimum and maximum deviation value observed across evaluated pairs of computing nodes, on a percentile-based range, on a range defined relative to a central tendency metric and dispersion metric, or on another distribution-derived reference interval. Deriving visualization bounds from the peer-relative performance distribution may ensure that visual encoding reflects comparative context of the peer group rather than arbitrary absolute ranges.

Scaling of visual attributes based on distribution-derived visualization bounds may enable perceptual differentiation of peer-relative variation that may otherwise appear visually uniform. For example, when comparative performance values are tightly clustered within a narrow range, mapping visual attributes to a wide fixed numerical range may result in minimal visible differentiation among node pair representations. By contrast, dynamically scaling visual attributes to a narrower range derived from dispersion characteristics of the peer-relative performance distribution may amplify subtle differences in comparative behavior, thereby making emerging divergence perceptible to a human reviewer.

Automatic scaling may include adjusting a color gradient, adjusting intensity or saturation ranges, adjusting brightness levels, or adjusting numerical mapping intervals used for visual encoding. Scaling may compress or expand the mapping between numerical deviation measures and visual attributes so that meaningful comparative variation occupies a substantial portion of the available visual spectrum. Such scaling may increase sensitivity of the visualization to peer-relative divergence without modifying underlying deviation computations.

In some implementations, visualization scaling may be performed in conjunction with generation of machine-readable node pair deviation states. In such implementations, visualization bounds may be selected to emphasize distinctions among encoded classifications, such as peer-relative conformance, intermediate divergence, and peer-relative underperformance. In other implementations, visualization scaling may be performed independently of machine-readable node pair deviation state classification. For example, aggregated bidirectional performance parameter values may be mapped directly to visual attributes using distribution-derived visualization bounds without performing threshold-based deviation classification. Independent visualization of aggregated comparative performance values may enable human reviewers to observe continuous performance gradients rather than discrete classification categories.

Automatic determination of visualization bounds based on the peer-relative performance distribution may therefore provide a statistically grounded and context-aware visual scaling mechanism. Such mechanisms may enhance visibility of relative performance differences that are small in absolute magnitude but significant within the comparative context of the peer group. By aligning visual encoding with distribution characteristics, the interactive cluster performance visualization artifact may support detection of emerging divergence patterns and correlated topology effects across the cluster of computing nodes.

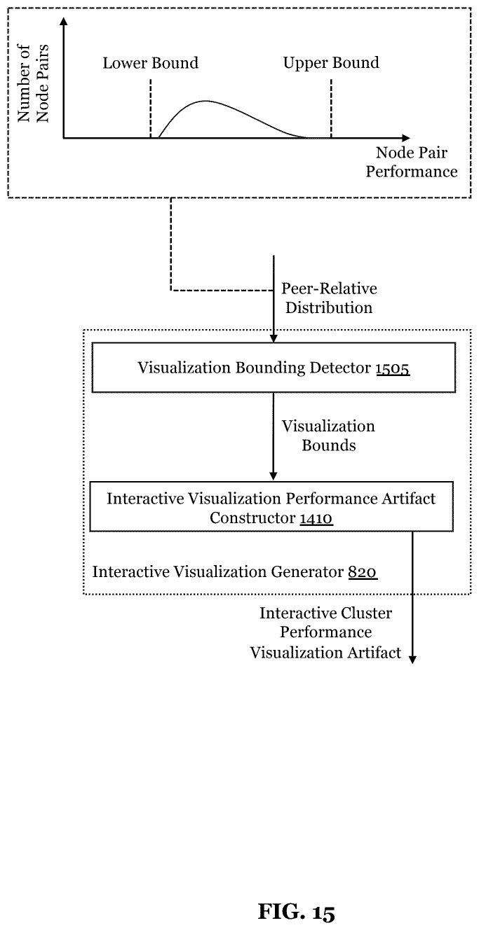

In a non-limiting example, as described with reference to FIG. 15, interactive visualization generator 820 may include a visualization bounding detector 1505 capable of determining visualization bounds for the interactive visualization performance artifact. For instance, the visualization bounding detector 1505 may detect a lower bound of the peer group distribution and an upper bound of the peer group distribution and may provide an indication of the associated bounds to interactive visualization performance artifact constructor 1410. When interactive visualization performance artifact constructor 1410 constructs the interactive cluster performance visualization artifact, interactive visualization performance artifact constructor 1410 may integrate the visualization bounds into the interactive visualization performance artifact.

An example of visualization bounds may be depicted with reference to FIG. 16A. For instance, an upper bound 1625 and/or a lower bound 1635 may be determined using the peer group distribution. In some examples, the thresholds between each of regions 1640A, 1640B, or 1640C may be set based on the value associated with the upper bound 1625 and/or the lower bound 1635 (e.g., may be set to be located at a proportional distance along the color gradient 1630 regardless of the upper and lower bounds). Alternatively, in examples where the color gradient 1630 is continuous, the color of grid cells may vary even with small variances in values of the upper bound 1625 and lower bound 1635. Accordingly, setting the upper and lower bounds to encapsulate a smaller range (e.g., rather than a predefined one) may enable greater visual distinguishability of grid cells.

### 3.3.3 Dynamic Updating of the Interactive Cluster Performance Visualization Artifact

In some implementations, generating the interactive cluster performance visualization artifact may further include dynamically updating the interactive cluster performance visualization artifact in response to changes in computing node health testing data and corresponding updates to machine-readable node pair deviation states. Dynamic updating may enable the interactive cluster performance visualization artifact to reflect evolving peer-relative performance behavior across the peer group of computing nodes in near-real-time.

Dynamic updating may include detecting execution of additional computing node health tests associated with one or more computing nodes of the peer group. Additional computing node health tests may be executed during idle operational states, during scheduled micro-jobs between workload executions, or as part of periodic diagnostic cycles. Upon detection of additional computing node health testing data, the cluster performance insight interface may derive updated bidirectional performance information, compute updated peer-relative performance distribution characteristics, and compute updated quantified degrees of peer-relative performance deviation.

When updated deviation measures result in modified machine-readable node pair deviation states, dynamic updating may include propagating updated classification information to corresponding node pair representations within the interactive cluster performance visualization artifact. Propagation may include modifying color values, color intensities, graphical annotations, or other visual attributes associated with the affected node pair representations. Such modification may occur without manual refresh by a user and may be performed automatically in response to newly derived deviation measures.

Dynamic updating of the interactive cluster performance visualization artifact may enable identification of peer-relative underperformance as cluster conditions change. For example, gradual degradation of comparative performance behavior associated with a computing node may result in progressive changes in visual encoding across multiple node pair representations involving the computing node. Near-real-time propagation of updated deviation states to the visualization layer may enable a human reviewer to observe emerging divergence patterns shortly after additional computing node health testing data becomes available.

Dynamic updating may further enable rapid confirmation of remediation actions. When a computing node transitions to a restricted operational state, undergoes maintenance, or is reintroduced to the peer group following corrective action, subsequent computing node health testing data may reflect altered comparative performance behavior. Updated machine-readable node pair deviation states may be propagated to the interactive cluster performance visualization artifact, thereby visually indicating restoration of peer-relative conformance or continued divergence.

Near-real-time reflection of peer-relative underperformance within the interactive cluster performance visualization artifact may enable proactive workload placement adjustments, isolation of suspect computing nodes, or targeted diagnostic actions before performance degradation affects long-duration workloads through early detection of emerging divergence patterns. Continuous visual synchronization between deviation computation and graphical representation may therefore support timely operational decision-making within the cluster of computing nodes.

Dynamic updating of the interactive cluster performance visualization artifact may thus function as a temporal bridge between ongoing comparative performance analysis and human or automated operational response mechanisms. By ensuring that visualization remains aligned with current peer-relative performance intelligence, the interactive cluster performance visualization artifact may complement automated cluster management interfaces described herein and may enhance overall responsiveness of performance-sensitive computing environments.

### 3.3.4 Multi-Threshold Visual Encoding of Intermediate Peer-Relative Performance States

In some implementations, the interactive cluster performance visualization artifact may support visual differentiation among multiple degrees of peer-relative performance divergence. Multi-level deviation classification described herein may include evaluation of a quantified degree of peer-relative performance deviation against more than one performance deviation threshold. Visual encoding mechanisms described herein may reflect such multi-threshold evaluation by mapping distinct deviation classifications to distinguishable visual attributes within node pair representations.

For example, a first performance deviation threshold may correspond to significant peer-relative underperformance, while a second performance deviation threshold may correspond to emerging or intermediate divergence. When a quantified degree of peer-relative performance deviation associated with a respective pair of computing nodes satisfies the second performance deviation threshold but does not satisfy the first performance deviation threshold, the machine-readable node pair deviation state may represent an intermediate deviation classification. The interactive cluster performance visualization artifact may encode such intermediate deviation classification using a visually distinct attribute that differs from both peer-relative conformance and peer-relative underperformance encodings.

Visual differentiation among conformance, intermediate divergence, and underperformance classifications may be achieved using distinct color hues, graduated color intensities, segmented color bands, graphical overlays, or annotated markers. For example, peer-relative conformance may be represented using a first region of a color spectrum, intermediate divergence may be represented using a second region of the color spectrum, and significant peer-relative underperformance may be represented using a third region of the color spectrum. Alternatively, intensity modulation may be used to reflect severity while hue variation may reflect classification category.

Multi-threshold visual encoding may enable identification of computing nodes exhibiting gradual performance drift prior to reaching levels classified as significant underperformance. For example, a computing node participating in multiple node pair representations encoded with intermediate deviation indicators may be exhibiting emerging divergence relative to the peer group. Such emerging divergence may not yet trigger automated operational restrictions but may warrant monitoring, targeted diagnostic evaluation, or workload-aware placement considerations.

Multi-level visual encoding may further support differentiation between transient moderate variation and sustained significant divergence when combined with temporal stability evaluation described herein. Node pair representations reflecting intermediate deviation across multiple assessment intervals may visually cluster in patterns distinct from isolated intermediate deviation occurrences. Such clustering may enable a human reviewer to distinguish between noise-level variation and progressive degradation.

The interactive cluster performance visualization artifact may therefore support graded sensitivity to peer-relative performance divergence by mapping multiple deviation thresholds to visually distinguishable states. Such graded sensitivity may enhance interpretability of comparative performance behavior and may enable operational decisions that reflect not only presence of divergence but also severity and progression of divergence within the peer group of computing nodes.

### 3.3.5 Amplification of Fractional Deviations Via the Interactive Cluster Performance Visualization Artifact

It should be noted that the interactive cluster performance visualization artifact may automatically encode visual attributes of node pair representations in a manner that amplifies peer-relative performance deviations that are below one or more absolute performance acceptability thresholds. Absolute performance acceptability thresholds may include predefined throughput limits, service-level agreement constraints, or other standalone health criteria.

In order to amplify such deviations, which may be referred to as sub-absolute deviations or fractional deviations, visual mapping parameters may be adjusted so that comparative performance differences that are small in absolute magnitude become perceptible within the interactive cluster performance visualization artifact. For instance, visualization bounds may be set and/or node pair representations may be visually encoded in a manner that expands the effective visual range associated with the node pair representations. The expanded visual range may cause subtle fractional deviations to occupy a broader portion of a color gradient or intensity scale, thereby increasing perceptibility.

### 3.3.6 Workload-Aware Interpretation of Peer-Relative Performance

The interactive cluster performance visualization artifact may further support workload-aware interpretation of peer-relative performance behavior. Workloads executed within the cluster of computing nodes may exhibit varying sensitivity to comparative performance divergence. Long-duration model training workloads, high-throughput computing workloads, and latency-sensitive workloads may be more sensitive to small comparative performance differences than short-duration or fault-tolerant workloads. Visual encoding within the interactive cluster performance visualization artifact may therefore be interpreted in the context of performance sensitivity or duration characteristics associated with a target workload.

In some implementations, the interactive cluster performance visualization artifact may include visual cues or annotations indicating suitability of computing nodes for execution of a target workload category. For example, node pair representations associated with computing nodes exhibiting consistent peer-relative conformance may be visually distinguishable from node pair representations associated with computing nodes exhibiting emerging divergence. A human reviewer evaluating workload placement for a long-duration or performance-sensitive workload may visually identify computing nodes associated with predominantly conforming node pair representations and may preferentially select such computing nodes for assignment.

### 3.4 Receiving, Via a Graphical User Interface Rendering the Interactive Cluster Performance Visualization Artifact, User Input Selecting a Computing Node

In some implementations, process 900 may further include step S940, which may include receiving, via a graphical user interface rendering the interactive cluster performance visualization artifact, a user input selecting a computing node. Step S940 may function to enable interactive engagement with peer-relative performance intelligence presented in step S930.

Receiving a user input selecting a computing node may include detecting interaction with one or more node pair representations visually encoded to reflect peer-relative performance classifications. A computing node participating in one or more node pair representations exhibiting peer-relative underperformance may be selected through interaction with a corresponding graphical element, identifier label, aggregated representation, or other selectable control within the graphical user interface.

Selection of a computing node may enable inspection of contextual performance information associated with the computing node. Contextual information may include aggregated bidirectional performance parameter values, quantified degrees of peer-relative performance deviation, deviation persistence indicators, historical comparative performance trends, hardware configuration information, or topology metadata. Presentation of contextual information may assist a human reviewer in evaluating scope and severity of comparative divergence prior to initiating corrective operations.

Step S940 may operate as a human-in-the-loop decision stage positioned between visual interpretation of peer-relative performance behavior and initiation of corrective operations described in step S950. In implementations supporting fully automated orchestration, machine-readable node pair deviation states may be consumed directly by cluster management interfaces without receiving user input (e.g., steps S930 and S940 may be skipped). However, in implementations supporting interactive oversight, receipt of user input selecting a computing node may serve as a trigger for subsequent operational control actions.

In a non-limiting example, as described with reference to FIG. 8B, graphical user interface 825 may be configured to receive a node selection input and to provide a corrective action trigger to cluster management module 815 upon receiving the node selection input. In an example of performing a node selection input, as depicted with reference to FIG. 16A, user input may be provided to a grid cell (e.g., grid cell 1620A) which may enable a user to select a corresponding one or more nodes for which corrective action is to be performed (e.g., node 1615A or 1615C for grid cell 1620). Alternatively, user input may be provided to the label on the axis associated with a node (e.g., the label associated with node 1615C). Alternatively, user input may be provided in a separate menu in which a user may select nodes to be indicated in the corrective action trigger.

### 3.5 Triggering Corrective Actions Through a Cluster Management Interface

Process 900 may further include step S950, which may include triggering a cluster management interface to initiate one or more corrective actions on a computing node associated with at least one node pair representation exhibiting peer-relative underperformance. Step S950 may function to convert peer-relative performance intelligence derived in step S920 and/or node selections in S940 into operational control actions within the cluster of computing nodes.

Triggering the cluster management interface may involve exposing machine-readable node pair deviation states or other control signals to a control component responsible for workload placement, scheduling, resource allocation, node state transitions, or other operational characteristics of the cluster of computing nodes. A “cluster management interface” may refer to a computer-implemented orchestration component executing on or in communication with an administrative computing node of the cluster of computing nodes.

In a first implementation, triggering the cluster management interface may occur automatically in response to machine-readable node pair deviation states indicating peer-relative underperformance. Machine-readable node pair deviation states may be transmitted, published, written to a configuration datastore, or otherwise made available as consumable data signals. The cluster management interface may evaluate such signals and initiate corrective actions without human intervention.

In a second implementation, triggering the cluster management interface may occur in response to user input received in step S940. Under such implementation, a graphical user interface rendering the interactive cluster performance visualization artifact may serve as an intermediary control layer. Selection of a computing node exhibiting peer-relative underperformance may result in generation of a control signal directing the cluster management interface to initiate one or more corrective actions affecting the selected computing node.

A “corrective action” may refer to an operational modification applied to a computing node in response to peer-relative performance evaluation. Corrective actions may include modification of workload eligibility, reassignment of scheduling priority, transition to a restricted or quarantine operational state, routing for additional diagnostic evaluation, formation of performance-sensitive groupings, or other cluster management adjustments. Corrective actions may be initiated immediately upon detection of defined deviation conditions or may be initiated following evaluation of persistence criteria, workload sensitivity considerations, or policy constraints.

Step S950 may therefore provide a control integration stage that enables adaptive management of the cluster of computing nodes based on detected performance conditions. By enabling triggering of corrective actions through automated orchestration or human-confirmed intervention, step S950 may support proactive workload placement, mitigation of performance instability, and preservation of efficiency within performance-sensitive computing environments.

In a first non-limiting example representing a fully automated approach for initiating corrective action, as depicted with reference to FIG. 8A, deviation states may be provided from node pair deviation state detector 805 to peer group performance insight module 810. Peer group performance insight module 810 may generate a corrective action trigger to provide to cluster management module 815. Cluster management module 815, in turn, may provide a signal for corrective action to an administrator node, which may then initiate corrective action on one or more associated nodes. The corrective action trigger may be the node deviation states themselves, in which case the cluster management module 815 may evaluate the deviation states to determine whether a corrective action (and which one) should be performed on any computing nodes. Alternatively, peer group performance insight module 810 may determine which computing nodes should be indicated to cluster management module 815 for corrective action. Peer group performance insight module 810, in some examples, may further determine which corrective action to perform on the computing nodes and may provide an indication of the corrective action along with an indication of the computing nodes.

In a second non-limiting example representing a semi-automated approach as described with reference to FIG. 8B, user input provided to graphical user interface 825 selecting a node may result in generation of a corrective action trigger that is provided to cluster management module 815. Cluster management module 815 may then signal a corresponding corrective action to the administrator node for the selected computing node. In some examples, the corrective action trigger may include an indication of which corrective action should be performed on the selected node (e.g., as specified via a user). Alternatively, the cluster management module 815 may determine automatically which corrective action is to be performed on the computing node.

### 3.5.1 Performance-Sensitive Grouping of Computing Nodes Based on Peer-Relative Conformance

In some implementations, initiating corrective operations in response to machine-readable node pair deviation states may include establishing or modifying logical groupings of computing nodes based on peer-relative performance classification. Logical grouping may include forming a subset of computing nodes within the cluster of computing nodes that are designated as eligible for execution of performance-sensitive workloads.

Performance-sensitive workloads may include long-duration computational jobs, distributed model training operations, high-throughput parallel processing tasks, latency-sensitive transactions, or other workloads for which sustained and consistent comparative performance behavior across participating computing nodes is desirable. Execution of such workloads on computing nodes exhibiting peer-relative underperformance or emerging divergence may increase risk of extended job duration, synchronization delays, checkpoint inefficiencies, or premature workload termination.

In response to exposure of machine-readable node pair deviation states indicating peer-relative conformance for a subset of computing nodes, the cluster management interface may designate such computing nodes as members of a performance-sensitive grouping. Designation may include assigning a logical partition identifier, setting an eligibility attribute, modifying scheduling priority metadata, or updating resource allocation rules associated with the computing nodes.

Computing nodes associated with machine-readable node pair deviation states indicating peer-relative underperformance or intermediate divergence may be excluded from the performance-sensitive grouping. Exclusion may prevent assignment of performance-sensitive workloads to computing nodes exhibiting comparative performance instability or degradation relative to the peer group. Such exclusion may occur automatically based on deviation classification or may occur following user confirmation.

Performance-sensitive grouping based on peer-relative conformance may enable selective reservation of computing nodes exhibiting stable comparative behavior for execution of critical or resource-intensive workloads. By contrast, computing nodes exhibiting peer-relative underperformance may remain eligible for execution of less performance-sensitive workloads, diagnostic workloads, or short-duration tasks that are tolerant of comparative variation.

In some implementations, performance-sensitive grouping may be dynamically updated as machine-readable node pair deviation states are updated. For example, when a computing node transitions from peer-relative underperformance to peer-relative conformance following remediation, the cluster management interface may automatically reintegrate the computing node into the performance-sensitive grouping. Conversely, when a computing node transitions to peer-relative underperformance, the computing node may be automatically removed from the performance-sensitive grouping.

Establishing and maintaining performance-sensitive groupings based on peer-relative performance classification may therefore support workload placement strategies that prioritize comparative stability rather than solely absolute health metrics. Such grouping may reduce probability of performance bottlenecks caused by heterogeneous comparative behavior within distributed workloads and may improve predictability of execution time for performance-sensitive operations within the cluster of computing nodes.

### 3.5.2 Routing Computing Nodes for Additional Diagnostic Evaluation and Preventative Maintenance

In some implementations, initiating corrective operations in response to machine-readable node pair deviation states may include routing one or more computing nodes for additional diagnostic evaluation. Routing for additional diagnostic evaluation may be performed when peer-relative performance classification indicates emerging divergence, sustained intermediate deviation, or peer-relative underperformance relative to the peer group.

Routing for additional diagnostic evaluation may include scheduling execution of extended computing node health tests beyond routine pairwise testing described herein. Extended computing node health tests may include prolonged stress testing of processing components, sustained network throughput evaluation, thermal performance characterization, memory integrity testing, storage input-output validation, or other targeted evaluation procedures designed to isolate root causes of comparative performance divergence.

In some implementations, routing may include assigning a computing node to a designated diagnostic partition or maintenance partition (e.g., a quarantine partition) within the cluster of computing nodes. The designated diagnostic partition may restrict participation of the computing node in production workloads while permitting execution of diagnostic workloads. Diagnostic workloads may be selected to evaluate specific subsystems suspected of contributing to peer-relative performance divergence.

Routing for additional diagnostic evaluation may be triggered when a machine-readable node pair deviation state indicates persistent intermediate deviation even if the quantified degree of peer-relative performance deviation does not satisfy a higher performance deviation threshold associated with restricted or quarantine operational states. Such routing may therefore support preventative maintenance by enabling early investigation of emerging divergence patterns prior to severe underperformance.

Routing computing nodes for additional diagnostic evaluation based on peer-relative performance intelligence may enable proactive identification of hardware degradation, interconnect instability, cooling inefficiencies, or configuration inconsistencies before such conditions manifest as absolute performance failures. Preventative maintenance guided by peer-relative deviation analysis may reduce unplanned downtime, minimize disruption of long-duration workloads, and extend operational lifespan of components within the cluster of computing nodes.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A computer-program product for peer-relative performance management in a cluster of computing nodes, the computer-program product storing computer instructions that, when executed by processing circuitry, perform operations comprising:
implementing a cluster performance insight interface in operable command communication with an administrative computing node of the cluster of computing nodes;
accessing, via the cluster performance insight interface, computing node pair health testing data associated with a peer group of the cluster of computing nodes;
deriving, for each of two or more pairs of computing nodes of the peer group, bidirectional performance information characterizing a performance of the respective pair of computing nodes;
computing a peer-relative performance distribution across the peer group of computing nodes based on the derived bidirectional performance information;
automatically generating, for each pair of computing nodes of the two or more pairs, a machine-readable node pair deviation state, wherein automatically generating the machine-readable node pair deviation state for a pair of computing nodes comprises:
computing a quantified degree of peer-relative performance deviation for the pair based on the respective bidirectional performance information and the peer-relative performance distribution;
determining whether the quantified degree of peer-relative performance deviation for the pair satisfies a performance deviation threshold;
encoding, within the node pair deviation state, an indication that the respective pair exhibits peer-relative underperformance when the quantified degree of peer-relative performance deviation satisfies the performance deviation threshold; and
encoding, within the node pair deviation state, an indication that the respective pair exhibits peer-relative conformance when the quantified degree of peer-relative performance deviation fails to satisfy the performance deviation threshold;
exposing the machine-readable node pair deviation states, wherein the machine-readable node pair deviation states are consumable data signals by one or more cluster management interfaces supporting operational control of workload placement and resource utilization within the cluster of computing nodes.

2. The computer-program product according to claim 1, wherein exposing the machine-readable node pair deviation states comprises:
providing the machine-readable node pair deviation states to a cluster management system, thereby enabling the cluster management system to initiate corrective actions on one or more computing nodes of the peer group.

3. The computer-program product according to claim 2, wherein initiating the corrective actions includes one or more of:
setting, for each of one or more computing nodes of the peer group exhibiting peer-relative underperformance according to the associated machine-readable node pair deviation states, a respective performance-sensitive workload eligibility status to a first mode in which the computing node is ineligible for assignment to performance-sensitive workloads; or
setting, for each of one or more computing nodes of the peer group exhibiting peer-relative conformance according to the associated machine-readable node pair deviation states, a respective performance-sensitive workload eligibility status to a second mode in which the computing node is eligible for assignment to performance-sensitive workloads.

4. The computer-program product according to claim 2, wherein setting the performance-sensitive workload eligibility status to the first mode transitions the respective computing node into a quarantine state in which the computing node is ineligible for assignment to any workloads.

5. The computer-program product according to claim 1, wherein deriving the bidirectional performance information for a respective pair of computing nodes comprises:
extracting, from the computing node pair health testing data, a plurality of bidirectional performance test results corresponding to multiple pairwise interactions between a first computing node and a second computing node within the peer group; and
aggregating the bidirectional test results to generate one or more bidirectional performance parameter values for the pair of computing nodes.

6. The computer-program product according to claim 5, wherein:
each bidirectional performance test result includes one or more bidirectional performance values, the one or more bidirectional performance values including:
a comparative data processing performance value representing a difference or ratio between a data processing rate of the first computing node and a data processing rate of the second computing node during a bidirectional test; or
a comparative data transmission performance value representing a difference or ratio between a data transmission rate observed in a first direction and a data transmission rate observed in a reverse direction of the bidirectional test; and
the one or more performance parameter values comprise:
an aggregated comparative data process performance value representing an aggregation of one or more comparative data process performance values within the extracted set of bidirectional performance test results;
an aggregated comparative data transmission performance value representing an aggregation of one or more comparative data transmission performance values within the extracted set of bidirectional performance test results.

7. The computer-program product according to claim 5, further comprising:
detecting, via the cluster performance insight interface, that additional computing node pair health testing data has been generated;
accessing the additional computing node pair health testing data via the cluster performance insight interface; and
updating the bidirectional performance information according to the updated additional computing node pair health testing data, thereby enabling the one or more cluster management interfaces to perform operational control of workload placement and resource utilization according to machine-readable deviation states updated in near-real-time.

8. The computer-program product according to claim 7, wherein updating the peer-relative bidirectional performance information comprises:
identifying one or more additional bidirectional performance test results corresponding to the additional computing node pair health testing data;
detecting that one or more previously received bidirectional performance test results exceed a temporal freshness threshold;
generating one or more updated bidirectional parameter values using the one or more additional bidirectional performance test results and excluding the one or more previously received bidirectional performance test results that exceed the temporal freshness threshold.

9. The computer-program product according to claim 1, wherein the computer instructions, when executed by the processing circuitry, perform operations further comprising:
computing the peer-relative performance distribution for the peer group comprises:
aggregating the bidirectional performance information from each pair of computing nodes to compute a central tendency metric and a dispersion metric; and
computing the quantified degree of peer-relative performance deviation for a respective pair of computing nodes comprises:
determining a directional performance offset of the bidirectional performance information associated with the respective pair of computing nodes relative to the central tendency metric of the peer-relative performance distribution; and
scaling the directional performance offset based on the dispersion metric of the peer-relative performance distribution to determine a normalized deviation measure.

10. The computer-program product according to claim 9, wherein the quantified degree of peer-relative performance deviation satisfies the performance deviation threshold when the normalized deviation measure satisfies a scaled directional performance offset threshold.

11. The computer-program product according to claim 1 wherein the computer instructions, when executed by the processing circuitry, perform operations further comprising:
detecting that a computing node has been removed from the peer group; and
updating the peer-relative performance distribution excluding the bidirectional performance information associated with any pairs including the computing node.

12. The computer-program product according to claim 1, wherein the computer instructions, when executed by the processing circuitry, perform operations further comprising:
applying a temporal stability criterion to the quantified degree of peer-relative performance deviation associated with a respective pair of computing nodes prior to encoding the machine-readable node pair deviation state, wherein:
applying the temporal stability criterion includes evaluating peer-relative performance deviations of the respective pair of computing nodes across a plurality of assessment intervals;
the respective pair of computing nodes is designated as exhibiting peer-relative conformance when the quantified degree of peer-relative performance deviation satisfies the performance deviation threshold for below a threshold quantity of assessment intervals; and
the respective pair of computing nodes is designated as exhibiting peer-relative underperformance when the quantified degree of peer-relative performance deviation satisfies the performance deviation threshold for above or at the threshold quantity of assessment intervals.

13. A computer-program product for peer-relative performance management in a cluster of computing nodes, the computer-program product storing computer instructions that, when executed by processing circuitry, perform operations comprising:
accessing computing node pair health testing data associated with a peer group of the cluster of computing nodes;
deriving, for each of two or more pairs of computing nodes of the peer group, bidirectional performance information characterizing a performance of the respective pair of computing nodes;
computing a peer-relative performance distribution across the peer group of computing nodes based on the derived bidirectional performance information;
automatically generating, for each pair of computing nodes of the two or more pairs, a machine-readable node pair deviation state, wherein automatically generating the machine-readable node pair deviation state for a pair of computing nodes comprises:
computing a quantified degree of peer-relative performance deviation for the pair based on the respective bidirectional performance information and the peer-relative performance distribution;
determining whether the quantified degree of peer-relative performance deviation for the pair satisfies a performance deviation threshold;
encoding, within the node pair deviation state, an indication that the respective pair exhibits peer-relative underperformance when the quantified degree of peer-relative performance deviation satisfies the performance deviation threshold; and
encoding, within the node pair deviation state, an indication that the respective pair exhibits peer-relative conformance when the quantified degree of peer-relative performance deviation fails to satisfy the performance deviation threshold;
automatically rendering an interactive cluster performance visualization artifact comprising a plurality of node pair representations corresponding to the peer group, wherein each node pair representation is encoded with visual attributes indicating the machine-readable node pair deviation state of the respective pair of computing nodes;
receiving, via a graphical user interface rendering the interactive cluster performance visualization artifact, a user input selecting a computing node with at least one node pair representation whose visual attributes indicate that the computing node is included in a pair exhibiting peer-relative underperformance;
in response to receiving the user input, initiating one or more corrective operations affecting the selected computing node.

14. The computer-program product according to claim 13, wherein encoding the visual attributes for a respective computing nodes includes:
mapping the quantified degree of peer-relative performance deviation for the computing node to one or more of a color value, a color intensity, a heatmap value, a graphical marker size, or a graphical annotation associated with the node pair representation, such that pairs of computing nodes exhibiting peer-relative conformance and pairs of computing nodes exhibiting peer-relative underperformance are visually distinguishable within the interactive cluster performance visualization artifact.

15. The computer-program product according to claim 13, wherein automatically generating the machine-readable node pair deviation state for the pair of computing nodes further comprises:
determining whether the quantified degree of peer-relative performance deviation satisfies a second performance deviation threshold, wherein:
encoding the indication that the respective pair exhibits peer-relative underperformance occurs when the quantified degree of peer-relative performance deviation satisfies the performance deviation threshold and the second performance deviation threshold; and
encoding the indication that the respective pair exhibits peer-relative conformance occurs when the quantified degree of peer-relative performance deviation fails to satisfy both the performance deviation threshold and the second performance deviation threshold; and
encoding, within the machine-readable node pair deviation state, an indication that the respective pair exhibits an intermediate degree of peer-relative performance when the quantified degree of peer-relative performance deviation satisfies the second performance deviation threshold and fails to satisfy the performance deviation threshold, wherein a corresponding node pair representation includes visual attributes indicating that the pair exhibits the intermediate degree of peer-relative performance when the machine-readable node pair deviation state is encoded with the intermediate degree of peer-relative performance.

16. The computer-program product according to claim 13, wherein generating the interactive cluster performance visualization artifact further includes:
automatically determining one or more visualization bounds based on the peer-relative performance distribution;
scaling at least one axis or color range of the visualization artifact based on the determined visualization bounds, wherein scaling the visualization artifact enables detection and visual differentiation of pairs of computing nodes exhibiting peer-relative conformance and pairs of computing nodes exhibiting peer-relative underperformance.

17. The computer-program product according to claim 13, wherein the computer instructions, when executed by the processing circuitry, perform operations further comprising:
dynamically updating the interactive cluster performance visualization artifact in response to updates to machine-readable node pair deviation states, wherein dynamically updating the interactive cluster performance visualization artifact comprises:
automatically detecting execution of additional computing node health tests associated with one or more computing nodes of the peer group;
updating the machine-readable node pair deviation states based on results of the additional computing node health tests; and
propagating the updated machine-readable node pair deviation states to modify corresponding node pair representations within the interactive cluster performance visualization artifact, thereby enabling the interactive cluster performance visualization artifact to be reflect whether a pair of computing nodes is exhibiting peer-relative underperformance in near-real-time.

18. The method according to claim 13, wherein the one or more corrective operations comprises one or more of:
re-testing of the identified computing node;
modifying a workload eligibility of the identified computing node; or
transitioning the identified computing node to a restricted or quarantine operational state within the cluster of computing nodes.

19. The computer-program product according to claim 13, wherein the computer instructions, when executed by the processing circuitry, perform operations further comprising:
receiving, via the graphical user interface rendering the interactive cluster performance visualization artifact, a user input selecting computing nodes sharing a common machine-readable node pair deviation state; and
in response to receiving the user input, automatically generating or modifying a logical resource grouping within the cluster of computing nodes by assigning the selected computing nodes to a designated operational partition, resource pool, or scheduling domain based on the shared machine-readable node pair deviation state.

20. A method for peer-relative performance management in a computing cluster, comprising:
implementing a cluster performance insight interface in operable command communication with an administrative computing node of the cluster of computing nodes;
accessing, via the cluster performance insight interface, computing node pair health testing data associated with a peer group of the cluster of computing nodes;
deriving, for each of two or more pairs of computing nodes of the peer group, bidirectional performance information characterizing a performance of the respective pair of computing nodes;
computing a peer-relative performance distribution across the peer group of computing nodes based on the derived bidirectional performance information;
automatically generating, for each pair of computing nodes of the two or more pairs, a machine-readable node pair deviation state, wherein automatically generating the machine-readable node pair deviation state for a pair of computing nodes comprises:
computing a quantified degree of peer-relative performance deviation for the pair based on the respective bidirectional performance information and the peer-relative performance distribution;
determining whether the quantified degree of peer-relative performance deviation for the pair satisfies a performance deviation threshold;
encoding, within the node pair deviation state, an indication that the respective pair exhibits peer-relative underperformance based on the quantified degree of peer-relative performance deviation satisfying the performance deviation threshold; and
exposing the machine-readable node pair deviation states, wherein the machine-readable node pair deviation states are consumable data signals by one or more cluster management interfaces supporting operational control of workload placement and resource utilization within the cluster of computing nodes.
